(19) United States
(12) Patent Application Publication
(10) Pub. No.: US 2018/0047348 A1
(43) Pub. Date: Feb. 15, 2018

(54) LIQUID CRYSTAL DISPLAY DEVICE

(71) Applicant: SHARP KABUSHIKI KAISHA, Sakai City, Osaka (JP)

(72) Inventors: KAZUYUKI YAMANAKA, Sakai City (JP); HAJIME WASHIO, Sakai City (JP)

(21) Appl. No.: 15/559,814

(22) PCT Filed: Mar. 15, 2016
(86) PCT No.: PCT/JP2016/058070

§ 371 Date: Sep. 19, 2017

(30) Foreign Application Priority Data
Mar. 19, 2015 (JP) 2015-056865

(51) Int. Cl. G09G 3/34; G02F 1/1335; G09G 3/36; G02F 1/1343

(52) U.S. Cl. CPC G09G 3/3413; G02F 1/13439; G02F 1/134309; G02F 1/133512; G02F 1/133528; G02F 1/133621; G09G 3/3607; G09G 3/3648; G02F 2001/133614; G09G 2320/0646; G09G 2320/0666; G09G 2300/0413

(57) ABSTRACT

A liquid crystal display device (100) in an embodiment according to the present invention includes an optical switch panel (30) that is provided between a liquid crystal display panel (10) and a backlight unit (20) or on an observer side of the liquid crystal display panel, and transmits and blocks light in a switched manner in one vertical scanning period. The optical switch panel includes a first substrate (31), a second substrate (32) and a liquid crystal layer (33) provided between the first substrate and the second substrate The first substrate includes a plurality of transparent electrodes (34). The second substrate includes a second transparent electrode (35) facing the plurality of first transparent electrodes. The first substrate further includes a plurality of metal lines (36) that are formed of a metal material and are each electrically connected with a corresponding first transparent electrode among the plurality of first transparent electrodes.

### TECHNICAL FIELD

The present invention relates to a liquid crystal display device, and specifically, to a liquid crystal display device displaying a high quality moving image.

### BACKGROUND ART

Recently, liquid crystal display devices are strongly desired to have high moving image display performance. A reason for this is that even liquid crystal display devices for use in a mobile device (e.g., for notebook computers or for smartphones), as well as liquid crystal TVs, display moving images more frequently.

In order to improve the moving image display performance of a liquid crystal display device, a liquid crystal material exhibiting a high response speed is used or over-driving is performed. The “over-driving” is a driving method of applying a gray scale voltage, different from a gray scale voltage to be applied in normal driving, is applied a liquid crystal layer in each of pixels (see, for example, Patent Document 1). A technology of flickering backlight to provide impulse-type display (referred to as “backlight impulse driving”) has also been proposed (see, for example, Patent Documents 2 and 3). A combined use of such techniques realizes, in a liquid crystal display device, moving image display performance of a level close to that of a CRT.

Recently, liquid crystal display devices are also desired to have a broader color reproduction range. For example, backlight having a high color rendering property may be used to broaden the color reproduction range.

Today, a pseudo white LED (light emitting diode) is generally used as a light source for backlight in a liquid crystal display device. The pseudo white LED includes a combination of an LED emitting blue light and a yellow phosphor excited by the blue light to emit yellow light. Thus, white light is emitted (therefore, the pseudo white LED is occasionally referred to as a “bluish yellow-type pseudo white LED”). However, the above-described pseudo white LED has a low color rendering property.

A light source including an LED emitting blue light, a green phosphor and a red phosphor has been proposed as a “high color rendering white LED” (e.g., Patent Document 4). The green phosphor is excited by blue light to emit green light, and the red phosphor is excited by blue light to emit red light.

A combined use of any of the above-described techniques for improving the moving image display performance, and the high color rendering white LED, is considered to provide a liquid crystal display device having high moving image display performance and a broad color reproduction range.

### CITATION LIST

### Patent Literature

Patent Document 1: Japanese Laid-Open Patent Publication No. 2001-265298

Patent Document 2: Japanese Laid-Open Patent Publication No. Hei 9-325715

Patent Document 3: Japanese Laid-Open Patent Publication No. 2000-275604

Patent Document 4: WO2009/110285

### SUMMARY OF INVENTION

### Technical Problem

However, the studies made by the present inventors have found that in the case where backlight impulse driving is performed on a liquid crystal display device including a high color rendering white LED as a light source for backlight, there occurs a problem that a red afterimage is visually recognized to decrease the display quality.

The present invention made in light of the above-described problems has an object of providing a liquid crystal display device capable of providing high quality moving image display.

### Solution to Problem

A liquid crystal display device in an embodiment according to the present invention includes a liquid crystal display panel; a backlight unit provided on a rear side of the liquid crystal display panel; and an optical switch panel provided between the liquid crystal display panel and the backlight unit or on an observer side of the liquid crystal display panel, the optical switch panel transmitting and blocking light in a switched manner in one vertical scanning period. The optical switch panel includes a first substrate and a second substrate facing each other and a liquid crystal layer provided between the first substrate and the second substrate. The first substrate includes a plurality of transparent electrodes formed of a transparent conductive material. The second substrate includes a second transparent electrode formed of a transparent conductive material, the second transparent electrode facing the plurality of first transparent electrodes. The first substrate further includes a plurality of metal lines formed of a metal material, and the plurality of metal lines are each electrically connected with a corresponding first transparent electrode among the plurality of first transparent electrodes.

In an embodiment, the liquid crystal display panel includes a black matrix; and a connection portion of each of the plurality of metal lines and each of the plurality of first transparent electrodes, and/or the plurality of metal lines, are located to overlap the black matrix.

In an embodiment, the optical switch panel includes a plurality of switching regions that are each switchable between a light transmitting state and a light blocking state; and either one of the plurality of first transparent electrodes is located in each of the plurality of switching regions.

In an embodiment, the plurality of switching regions each correspond to a region, in a display region of the liquid crystal display panel, that is scanned in one horizontal scanning period.

In an embodiment, the second substrate includes a light blocking layer provided between two adjacent switching regions among the plurality of switching regions.

In an embodiment, the plurality of switching regions each correspond to a region, in a display region of the liquid crystal display panel, that is scanned in two or more horizontal scanning periods.

In an embodiment, the first substrate includes a plurality of dummy lines not electrically connected with the plurality of first transparent electrodes; and at least one of the plurality of dummy lines is located between two adjacent metal lines among the plurality of metal lines.

In an embodiment, the plurality of switching regions each correspond to a region, in a display region of the liquid crystal display panel, that is scanned in M horizontal scanning periods (M is an integer of 2 or greater); and the plurality of dummy lines are provided in a number that is (M−1) times the number of the plurality of metal lines.

An other liquid crystal display device in an embodiment according to the present invention includes a liquid crystal display panel; a backlight unit provided on a rear side of the liquid crystal display panel; and an optical switch panel provided between the liquid crystal display panel and the backlight unit or on an observer side of the liquid crystal display panel, the optical switch panel transmitting and blocking light in a switched manner in one vertical scanning period. The optical switch panel includes a plurality of switching regions that are each switchable between a light transmitting state and a light blocking state. The plurality of switching regions each correspond to a region, in a display region of the liquid crystal display panel, that is scanned in one horizontal scanning period.

In an embodiment, the optical switch panel includes a first substrate and a second substrate facing each other and a liquid crystal layer provided between the first substrate and the second substrate; the first substrate includes a plurality of transparent electrodes formed of a transparent conductive material; the second substrate includes a second transparent electrode formed of a transparent conductive material, the second transparent electrode facing the plurality of first transparent electrodes; and either one of the plurality of first transparent electrodes is provided in each of the plurality of switching regions.

In an embodiment, the optical switch panel includes a plurality of MEMS shutters; and at least one of the plurality of MEMS shutters is located in each of the plurality of switching regions.

In an embodiment, the liquid crystal display panel includes a plurality of color display pixels; the plurality of color display pixels each include N pixels (N is an integer of 3 or greater); and a region, in the display region of the liquid crystal display panel, that is scanned in one horizontal scanning period is 1 or greater and N or less pixel row(s).

In an embodiment, the optical switch panel is provided between the liquid crystal display panel and the backlight unit. The liquid crystal display device further includes a first polarizer plate provided on an observer side of the liquid crystal display panel, a second polarizer plate provided between the liquid crystal display panel and the optical switch panel, and a third polarizer plate provided between the optical switch panel and the backlight unit.

In an embodiment, the optical switch panel is provided on an observer side of the liquid crystal display panel. The liquid crystal display device further includes a first polarizer plate provided on an observer side of the optical switch panel, a second polarizer plate provided between the optical switch panel and the liquid crystal display panel, and a third polarizer plate provided between the liquid crystal display panel and the backlight unit.

In an embodiment, the backlight unit includes a light emitting element emitting blue light, a green phosphor absorbing a part of the blue light emitted by the light emitting element and emitting green light, and a red phosphor absorbing a part of the blue light emitted by the light emitting element and emitting red light.

### Advantageous Effects of Invention

An embodiment of the present invention provides a liquid crystal display device capable of providing high quality moving image display.

### BRIEF DESCRIPTION OF DRAWINGS

FIG. 1 is an exploded isometric view schematically showing a liquid crystal display device 100 in an embodiment according to the present invention.

FIG. 2 is an isometric view schematically showing a liquid crystal display panel 10 included in the liquid crystal display device 100.

FIG. 3 schematically shows a TFT substrate 11 included in the liquid crystal display panel 10.

FIG. 4 is a plan view schematically showing a color filter substrate 12 included in the liquid crystal display panel 10.

FIG. 5 is a cross-sectional view schematically showing a white LED 20a usable as a light source for a backlight unit 20 included in the liquid crystal display device 100.

FIG. 6 is an isometric view showing an optical switch panel 30 included in the liquid crystal display device 100.

FIG. 7 schematically shows the optical switch panel 30.

FIG. 8 is a timing diagram of driving on the liquid crystal display panel 10 and the optical switch panel 30.

FIG. 9 is a timing diagram of driving on the liquid crystal display panel 10 and the optical switch panel 30.

FIG. 10 is a plan view schematically showing the optical switch panel 30 including light blocking layers 37.

FIG. 11 is an exploded isometric view schematically showing a liquid crystal display device 200 in an embodiment according to the present invention.

FIG. 12 is an isometric view schematically showing an optical switch panel 30A included in the liquid crystal display device 200.

FIG. 13 schematically shows the optical switch panel 30A.

FIG. 14 is a circuit diagram schematically showing a switching driver 38 included in the optical switch panel 30A.

FIG. 15 is a timing diagram of the switching driver 38.

FIG. 16 is a circuit diagram schematically showing a switching voltage selection portion 39 included in the optical switch panel 30A.

FIG. 17 is a circuit diagram schematically showing a switching voltage selector 39a included in the switching voltage selection portion 39.

FIG. 18 is a timing diagram of the switching voltage selection portion 39.

FIG. 19(a) and FIG. 19(b) schematically show the optical switch panel 30A; FIG. 19(a) shows a structure in which each of switching regions SR is a region corresponding to a 1H region; and FIG. 19(b) shows a structure in which each switching region SR is a region corresponding to a 2H region.

FIG. 20 schematically shows the optical switch panel 30A including a plurality of dummy lines 36D.

FIG. 21 schematically shows the optical switch panel 30A including an odd number pixel row driver Dodd and an even number pixel row driver Deven.

FIG. 22 is a timing diagram in the case where the structure shown in FIG. 21 is adopted.

FIG. 23 schematically shows the optical switch panel 30A including an odd number pixel row switching driver 38odd and an even number pixel row switching driver 38even.

FIG. 24(a) shows an example of pixel arrangement in the case where a 1H region corresponds to one pixel row, and FIG. 24(b) is a timing diagram of driving on pixels arranged as shown in FIG. 24(a).

FIG. 25(a) shows an example of pixel arrangement in the case where a 1H region corresponds to three pixel rows, and FIG. 25(b) is a timing diagram of driving on pixels arranged as shown in FIG. 24(a).

FIG. 26 is an exploded isometric view schematically showing a liquid crystal display device 300 in an embodiment according to the present invention.

FIG. 27(a) and FIG. 27(b) are each a cross-sectional view showing a structure in which the optical switch panel 30 (or 30A) is located between the liquid crystal display panel 10 and the backlight unit 20; FIG. 27(a) shows a structure in which the optical switch panel 30 (or 30A) is located such that the second substrate 32 is located on the side of the liquid crystal display panel 30, and FIG. 27(b) shows a structure in which the optical switch panel 30 (or 30A) is located such that the first substrate 31 is located on the side of the liquid crystal display panel 30.

FIG. 28(a) and FIG. 28(b) are each a cross-sectional view showing a structure in which the optical switch panel 30 (or 30A) is located on an observer side of the liquid crystal display panel 10; FIG. 28(a) shows a structure in which the optical switch panel 30 (or 30A) is located such that the second substrate 32 is located on the side of the liquid crystal display panel 30, and FIG. 28(b) shows a structure in which the optical switch panel 30 (or 30A) is located such that the first substrate 31 is located on the side of the liquid crystal display panel 30.

FIG. 29 is an exploded isometric view schematically showing a conventional liquid crystal display device 900.

FIG. 30 is an isometric view schematically showing a liquid crystal display panel 910 included in the liquid crystal display device 900.

FIG. 31(a), FIG. 31(b) and FIG. 31(c) each show an example of display image in a CRT, and FIG. 31(d) is a graph showing the relationship between the light emission intensity of a pixel P×A and the time T in the case where the display shown in FIG. 31(a), FIG. 31(b) and FIG. 31(c) is provided.

FIG. 32(a), FIG. 32(b) and FIG. 32(c) each show an example of display image in a liquid crystal display device, and FIG. 32(d) is a graph showing the relationship between the light emission intensity of the pixel P×A and the time T in the case where the display shown in FIG. 32(a), FIG. 32(b) and FIG. 32(c) is provided.

FIG. 33(a), FIG. 33(b) and FIG. 33(c) each show an example of display image in a liquid crystal display device when backlight impulse driving is performed, and FIG. 33(d) is a graph showing the relationship between the light emission intensity of the pixel P×A and the time T in the case where the display shown in FIG. 33(a), FIG. 33(b) and FIG. 33(c) is provided.

FIG. 34 shows a state change (luminance change) of a blue LED, a green phosphor and a red phosphor in the case where the backlight unit is switched on (lit up) and off (extinguished) in repetition.

### DESCRIPTION OF EMBODIMENTS

Before describing embodiments of the present invention, a reason why a red afterimage is recognized to decrease the display quality will be described.

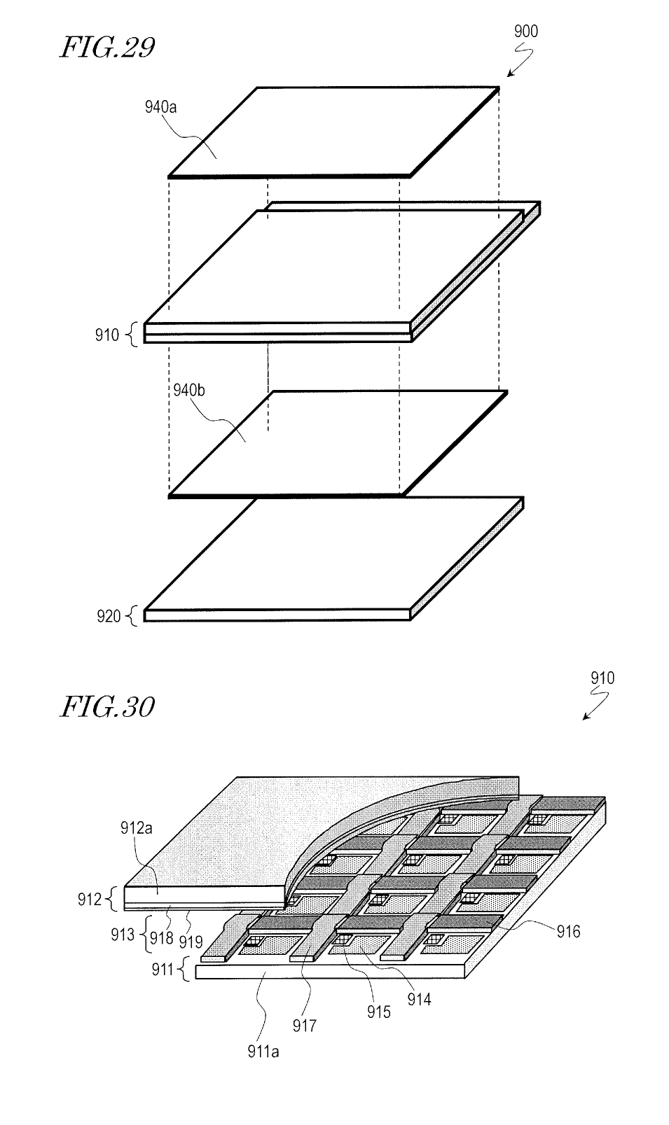

FIG. 29 shows a conventional liquid crystal display device 900. FIG. 29 is an exploded isometric view schematically showing the liquid crystal display device 900.

As shown in FIG. 29, the liquid crystal display device 900 includes a liquid crystal display panel 910 and a backlight unit 920 provided on a rear side of the liquid crystal display panel 910. The liquid crystal display device 900 further includes a first polarizer plate 940a provided on an observer side of the liquid crystal display panel 910 and a second polarizer plate 940b provided between the liquid crystal display panel 910 and the backlight unit 920.

As shown in FIG. 30, the liquid crystal display panel 910 includes an active matrix substrate 911, a color filter substrate 912 facing the active matrix substrate 911, and a liquid crystal layer 913 provided between the active matrix substrate 911 and the color filter substrate 912.

The active matrix substrate 911 includes pixel electrodes 914 respectively provided in pixels and thin film transistors (TFTs) 915 electrically connected with the pixel electrodes 914 respectively. The active matrix substrate 911 further includes scanning lines 916 supplying a scanning signal to the TFTs 915, and signal lines 917 supplying a display signal to the TFTs 915. The components of the active matrix substrate 911 (the above-described pixel electrodes 914 and the like) are supported by a glass substrate 911a.

The color filter substrate 912 includes a color filter layer 918 and a counter electrode 919 provided on the color filter layer 918. The components of the color filter substrate 914 (the above-described color filter layer 918 and the like) are supported by a glass substrate 912a.

Liquid crystal molecules contained in the liquid crystal layer 30 have an alignment state thereof changed in accordance with a voltage applied between each of the pixel electrodes 914 and the counter electrode 919 (namely, applied to the liquid crystal layer 30).

The liquid crystal display device 900 provides display by modulating light emitted from the backlight unit 920 by each of the pixels in the liquid crystal display panel 920. For display, the backlight unit 920 is always in an ON state. In a time period after one pixel is scanned until the one pixel is scanned again, the luminance of the pixel is kept constant. Such manner of display is referred to as “hold-type display”.

By contrast, a CRT (Cathode Ray Tube) provides display by sequentially causing a phosphor provided on a display surface to emit light by electrons emitted by an electron gun. Therefore, the phosphor in each of the pixels emits light at the moment when the electrons collide against the phosphor and for a very short time period after that. Namely, in a time period after one pixel is scanned until the one pixel is scanned again, the luminance of the pixel is not kept constant. Such manner of display is referred to as “impulse-type display”.

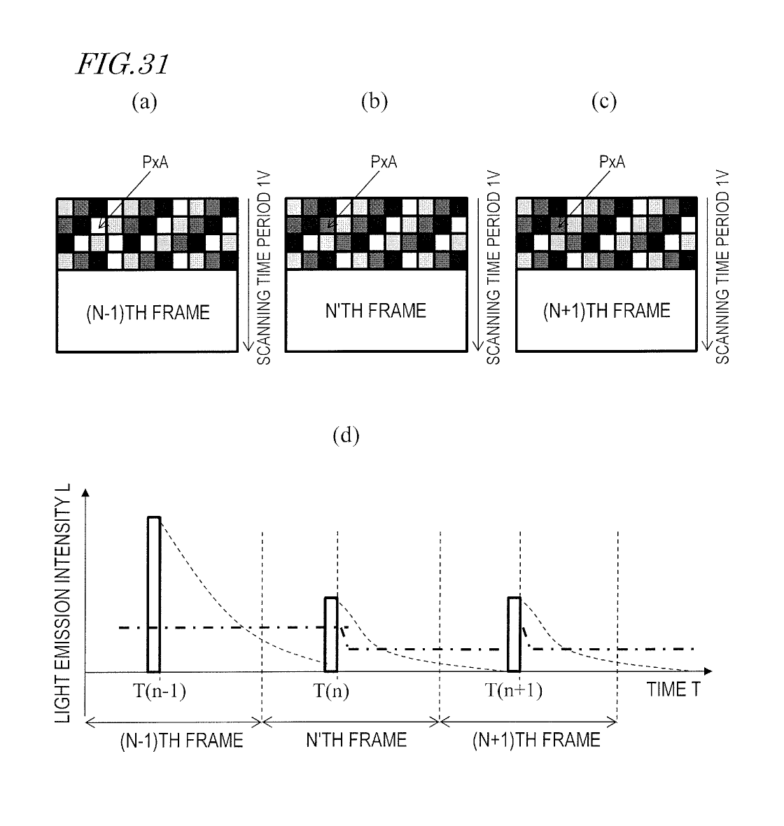

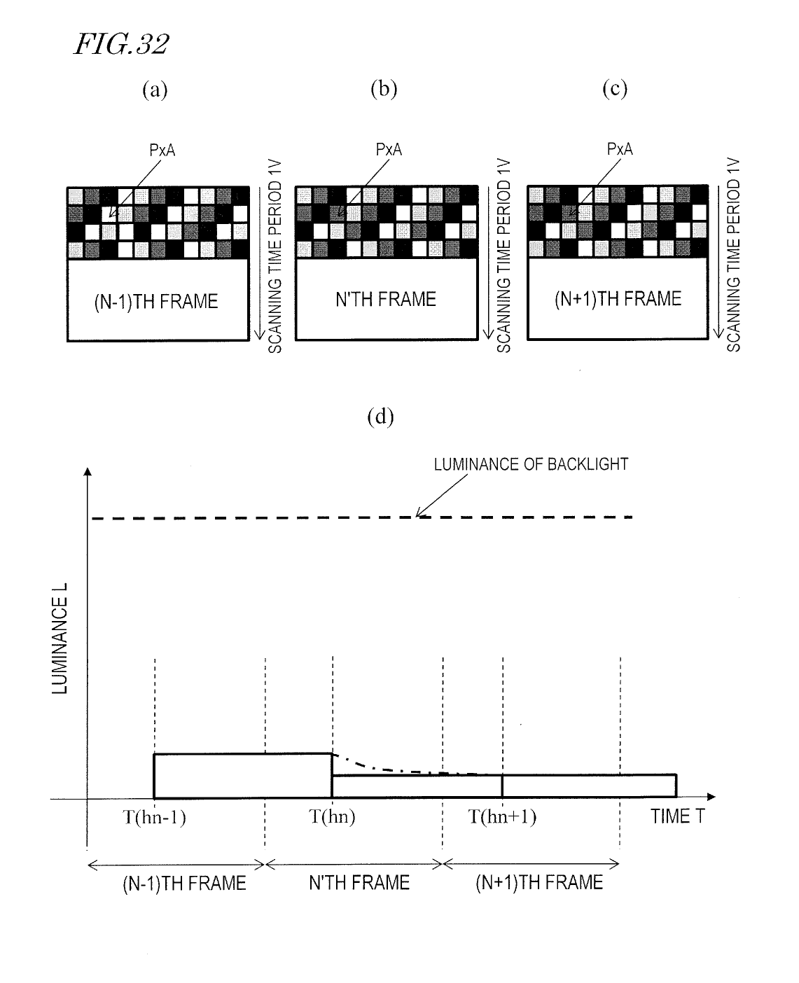

FIG. 31(a), FIG. 31(b) and FIG. 31(c) each show an example of image displayed on a CRT. In the example in FIG. 31(a), a pixel P×A provides white display in the (N−1)th frame. In the example in FIG. 31(b), the pixel P×A provides gray display in the N'th frame. In the example in FIG. 31(c), the pixel P×A provides gray display in the (N+1)th frame.

FIG. 31(d) shows the relationship between the light emission intensity L of the pixel P×A and the time T in the case where the display shown in FIG. 31(a), FIG. 31(b) and FIG. 31(c) is provided. One vertical scanning period is 1/60 sec. FIG. 31(d) shows the light emission intensity L of the pixel P×A with the solid line. As shown in FIG. 31(d), in the (N−1)th frame, the pixel P×A emits light at time T(n−1). In the N'th frame, the pixel P×A emits light at time T(n). In the (N+1)th frame, the pixel P×A emits light at time T(n+1). In FIG. 31(d), the dotted line represents the brightness of the pixel P×A visually recognized by an observer. When the frequency of flickering of the pixel P×A is 60 Hz or higher, the observer does not recognize the flickering of the pixel P×A as flickering, and recognizes the brightness of the pixel P×A with an average light emission intensity (represented by the one-dot chain line in FIG. 31(d)). Therefore, in the case where the pixel P×A providing white display in the (N−1)th frame provides gray display in the N'th frame, the observer recognizes the decrease in the light emission intensity L of the pixel P×A as a difference in the average light emission intensity.

FIG. 32(a), FIG. 32(b) and FIG. 32(c) each show an example of image displayed on a liquid crystal display device. In the example in FIG. 32(a), a pixel P×A provides white display in the (N−1)th frame. In the example in FIG. 32(b), the pixel P×A provides gray display in the N'th frame. In the example in FIG. 32(c), the pixel P×A provides gray display in the (N+1)th frame.

FIG. 32(d) shows the relationship between the luminance L of the pixel P×A and the time T in the case where the display shown in FIG. 32(a), FIG. 32(b) and FIG. 32(c) is provided. One vertical scanning period is 1/60 sec. FIG. 32(d) shows the luminance L of the pixel P×A with the solid line. FIG. 32(d) also shows the light emission intensity of the backlight. As shown in FIG. 32(d), in the (N−1)th frame, the pixel P×A is scanned and a predetermined voltage (display voltage corresponding to white display) is applied to the liquid crystal layer at time T(n−1). In the N'th frame, the pixel P×A is scanned and a predetermined voltage (display voltage corresponding to gray display) is applied to the liquid crystal layer at time T(n). In the (N+1)th frame, the pixel P×A is scanned and a predetermined voltage (display voltage corresponding to gray display) is applied to the liquid crystal layer at time T(n+1). In the example shown in FIG. 32(d), the luminance L of the pixel P×A is changed at time T(n) in the N'th frame. At this point, the observer recognizes the brightness of the pixel P×A with the average of the luminance L of the pixel P×A in the (N−1)th frame and the luminance L of the pixel P×A in the N'th frame. As described above, in the hold-type display, the pixel is always in an ON state, and a time-wise change in the brightness of the pixel is not easily recognized clearly due to the influence of an afterimage to the eye. Therefore, in the case where moving image display in which images are switched at a high speed as in TV broadcasting or the like is provided, the observer recognizes the afterimage and thus the quality of the moving image is deteriorated.

In order to solve this problem, it has been proposed to perform backlight impulse driving on a liquid crystal display device to provide impulse-type display.

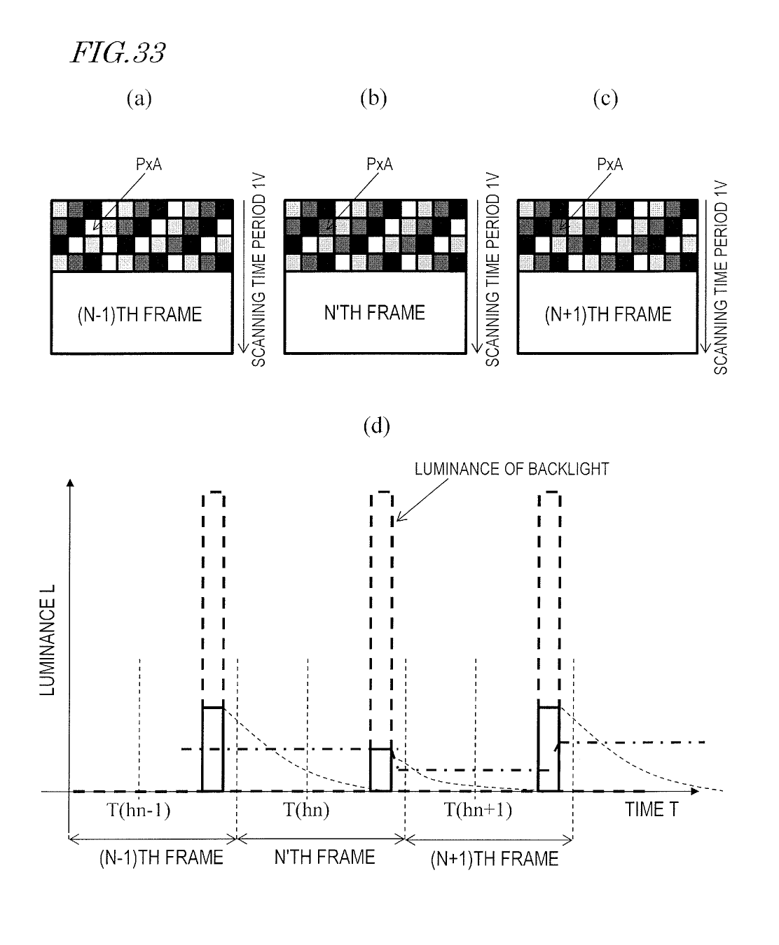

FIG. 33(a), FIG. 33(b) and FIG. 33(c) each show an example of image displayed on a liquid crystal display device by backlight impulse driving. In the example in FIG. 33(a), a pixel P×A provides white display in the (N−1)th frame. In the example in FIG. 33(b), the pixel P×A provides gray display in the N'th frame. In the example in FIG. 33(c), the pixel P×A provides gray display in the (N+1)th frame.

FIG. 33(d) shows the relationship between the luminance L of the pixel P×A and the time T in the case where the display shown in FIG. 33(a), FIG. 33(b) and FIG. 33(c) is provided. One vertical scanning period is 1/60 sec. FIG. 33(d) shows the luminance L of the pixel P×A with the solid line. FIG. 33(d) also shows the light emission intensity of the backlight. As seen from FIG. 33(d), the backlight unit does not emit light until all the pixels are scanned (until the display voltage is written to all the pixels) in each frame, and emits light only for a predetermined time period after the scanning is finished until the next scanning is started. Since the pixel P×A is in an ON state for a predetermined time period in each frame, the observer recognizes the change in the luminance L of the pixel P×A like in the case of the CRT (in FIG. 33(d), the dotted line represents the brightness of the pixel P×A due to the afterimage visually recognized by the observer, and the one-dot chain line represents the brightness of the pixel P×A recognized by the observer). Therefore, the moving image display performance is improved.

It is considered that by performing the above-described backlight impulse driving on a liquid crystal display device including a high color rendering white LED as a source for the backlight, high moving image display performance and a broad color reproduction range are both provided.

However, as described above, a combined use of the high color rendering white LED and the backlight impulse driving generates a red afterimage. The generation of a red afterimage is caused by the difference in the afterimage characteristics between the green phosphor and the red phosphor (more specifically, caused because an afterimage is more easily generated with the red phosphor than with the green phosphor).

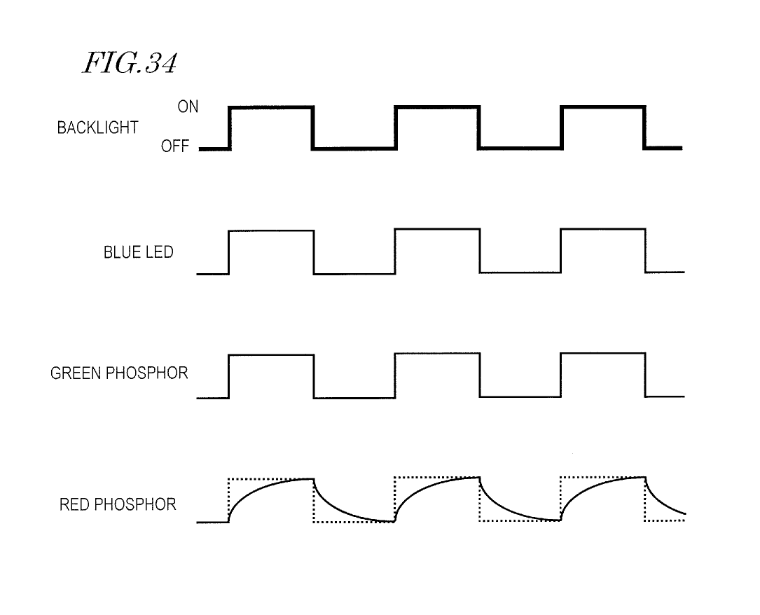

FIG. 34 shows a state change (luminance change) of the blue LED, the green phosphor and the red phosphor in the case where the backlight unit is switched on (lit up) and off (extinguished) in repetition. It is seen from FIG. 34 that the timing at which the red phosphor is lit up and extinguished is delayed from the timing at which the blue LED and the green phosphor are lit up and extinguished. Therefore, in the case where backlight impulse driving is performed on a liquid crystal display device including a high color rendering white LED as a light source, when the backlight is turned off, the light from the blue LED and the light from the green phosphor are extinguished immediately, but the light from the red phosphor remains as an afterimage. Therefore, in moving image display in which images are switched at high speed, a red afterimage is visually recognized.

By contrast, a liquid crystal display device in an embodiment according to the present invention prevents the above-described generation of a red afterimage.

Hereinafter, embodiments of the present invention will be described with reference to the drawings. The present invention is not limited to any of the following embodiments.

### Embodiment 1

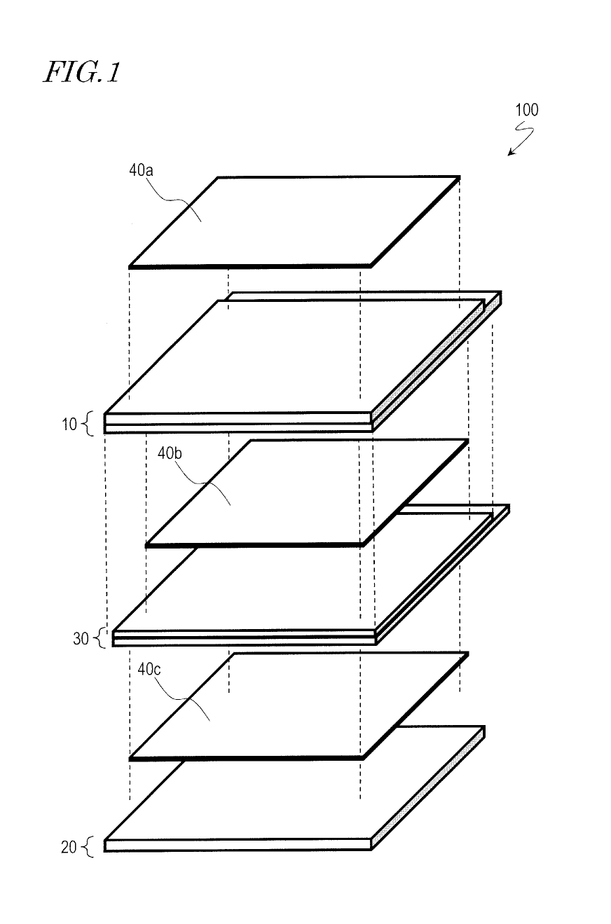

FIG. 1 shows a liquid crystal display device 100 in this embodiment. FIG. 1 is an exploded isometric view schematically showing the liquid crystal display device 100.

As shown in FIG. 1, the liquid crystal display device 100 includes a liquid crystal display panel 10, a backlight unit 20 located on a rear side of the liquid crystal display panel 10, and an optical switch panel 30 provided between the liquid crystal display panel 10 and the backlight unit 20. The liquid crystal display device 100 further includes a first polarizer plate 40a provided on an observer side of the liquid crystal display panel 10, a second polarizer plate 40b provided between the liquid crystal display panel 10 and the optical switch panel 30, and a third polarizer plate 40c provided between the optical switch panel 30 and the backlight unit 20.

The liquid crystal display panel 10 includes a plurality of color display pixels. The plurality of color display pixels each include N pixels (N is an integer of 3 or greater). In this example, each color display pixel includes a red pixel displaying red, a green pixel displaying green and a blue pixel displaying blue. Alternatively, each color display pixel may include four or more pixels. The plurality of pixels included in the color display pixel may include, for example, a yellow pixel in addition to the red pixel, the green pixel and the blue pixel. As the display mode of the liquid crystal display panel 10, any of various display modes is usable. For example, a TN (Twisted Nematic) mode, a VA (Vertical Alignment) mode, or a lateral electric field mode are usable. The VA mode is, for example, an MVA (Multi-domain Vertical Alignment) mode or a CPA (Continuous Pinwheel Alignment) mode. The lateral electric field mode may be an IPS (In-Plane Switching) mode or an FFS (Fringe Field Switching) mode.

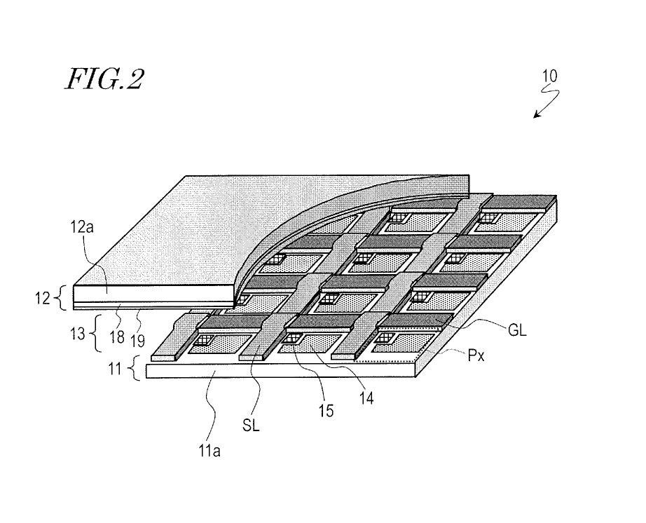

FIG. 2 shows a specific example of structure of the liquid crystal display panel 10. As shown in FIG. 2, the liquid crystal display panel 10 includes an active matrix substrate (hereinafter, referred to as a “TFT substrate”) 11, a color filter substrate 12 (may be referred to as a “counter substrate”) facing the TFT substrate 11, and a liquid crystal layer 13 provided between the TFT substrate 11 and the color filter substrate 12.

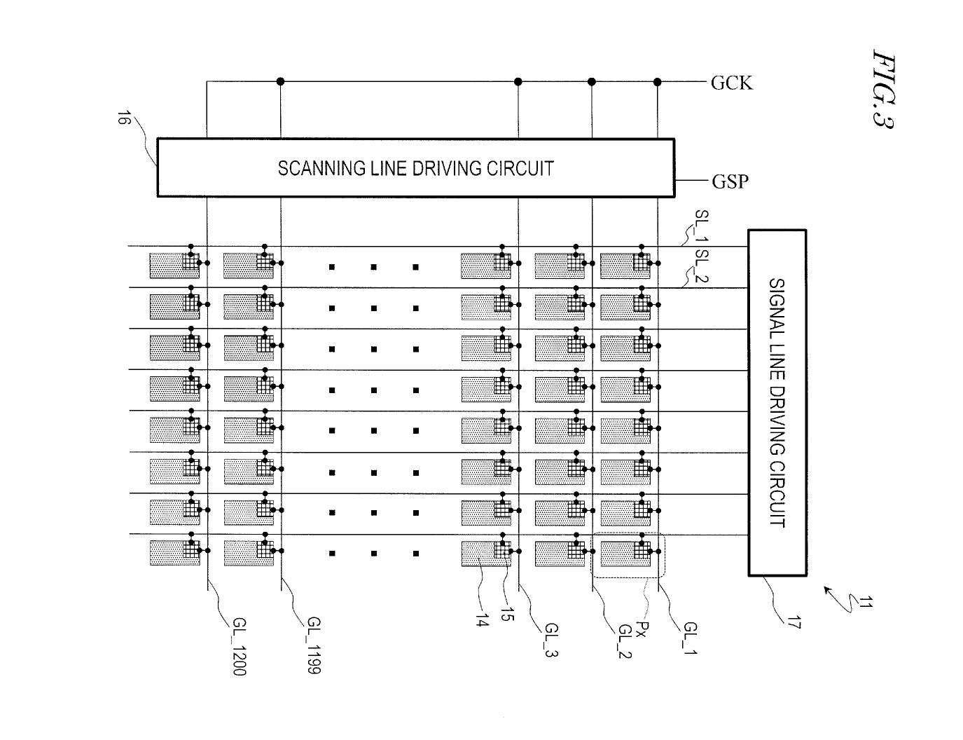

As shown in FIG. 2 and FIG. 3, the TFT substrate 11 includes pixel electrodes 14 respectively provided in a plurality of pixels Px and thin film transistors (TFTs) 15 electrically connected with the pixel electrodes 14 respectively. The TFT substrate 10 further includes scanning lines (gate bus lines) GL supplying a scanning signal to the TFTs 15 and signal lines (source bus lines) SL supplying a display signal to the TFTs 15. In FIG. 3, the scanning line GL corresponding to the n'th pixel row is labelled as “GL_n”, and the signal line SL corresponding to the n'th pixel column is labelled as “SL_n”. The scanning lines GL are each supplied with a scanning signal voltage from a scanning line driving circuit (gate driver) 16. The scanning line driving circuit 16 drives the scanning lines GL based on a gate clock signal GCK and a gate start pulse GSP. The signal lines SL are each supplied with a display signal voltage from a signal line driving circuit (source driver) 17. The components of the TFT substrate 11 (the above-described pixel electrodes 14 and the like) are supported by an insulating transparent substrate (e.g., glass substrate) 11a.

The color filter substrate 12 includes a color filter layer 18 and a counter electrode 19 provided on the color filter layer 18. As shown in FIG. 4, the color filter layer 18 includes red color filters 18R, green color filters 18G, blue color filters 18B and a black matrix (light blocking layer) BM. The red color filters 18R, the green color filters 18G and the blue color filters 18B are respectively provided in regions corresponding to the red pixels, regions corresponding to the green pixels, and regions corresponding to the blue pixels. The black matrix BM is provided to overlap the scanning lines GL, the signal lines SL, the TFTs 15 and the like. The counter electrode (also referred to as a “common electrode”) 19 is provided to face the pixel electrodes 14. In the case where the lateral electric field mode is used as the display mode, the common electrode is provided in the TFT substrate 10. The components of the color filter substrate 12 (the above-described color filter layer 18 and the like) are supported by an insulating transparent substrate (e.g., glass substrate) 12a.

As the liquid crystal layer 30, a horizontal alignment type liquid crystal layer or a vertical alignment type liquid crystal layer is provided in accordance with the display mode used. The TFT substrate 11 and the color filter substrate 12 each have an alignment film (not shown) provided on a surface thereof facing the liquid crystal layer 13.

The backlight unit 20 emits white light toward the liquid crystal display panel 10. The backlight unit 20 includes, as a light source, a white LED (light emitting diode) having a high color rendering property. FIG. 5 shows a specific example of structure of the while LED. A while LED 20a shown in FIG. 5 includes a light emitting element 21, a green phosphor 22 and a red phosphor 23.

The light emitting element 21 emits blue light. The green phosphor 22 absorbs, as exciting light, a part of the blue light emitted from the light emitting element 21, and emits green light. The red phosphor 23 absorbs, as exciting light, a part of the blue light emitted from the light emitting element 21, and emits red light. Specific examples of the green phosphor 22 and the red phosphor 23 will be described below in detail. The green phosphor 22 and the red phosphor 23 are enclosed in a sealing agent 24, and act as a wavelength conversion portion WC absorbing a part of light emitted from the light emitting element 21 and emitting light having a longer wavelength.

The backlight unit 20 may be, for example, of an edge light type. In this case, the backlight unit 20 includes a light guide plate that guides white light emitted from the white LED 20a toward the liquid crystal display panel 10.

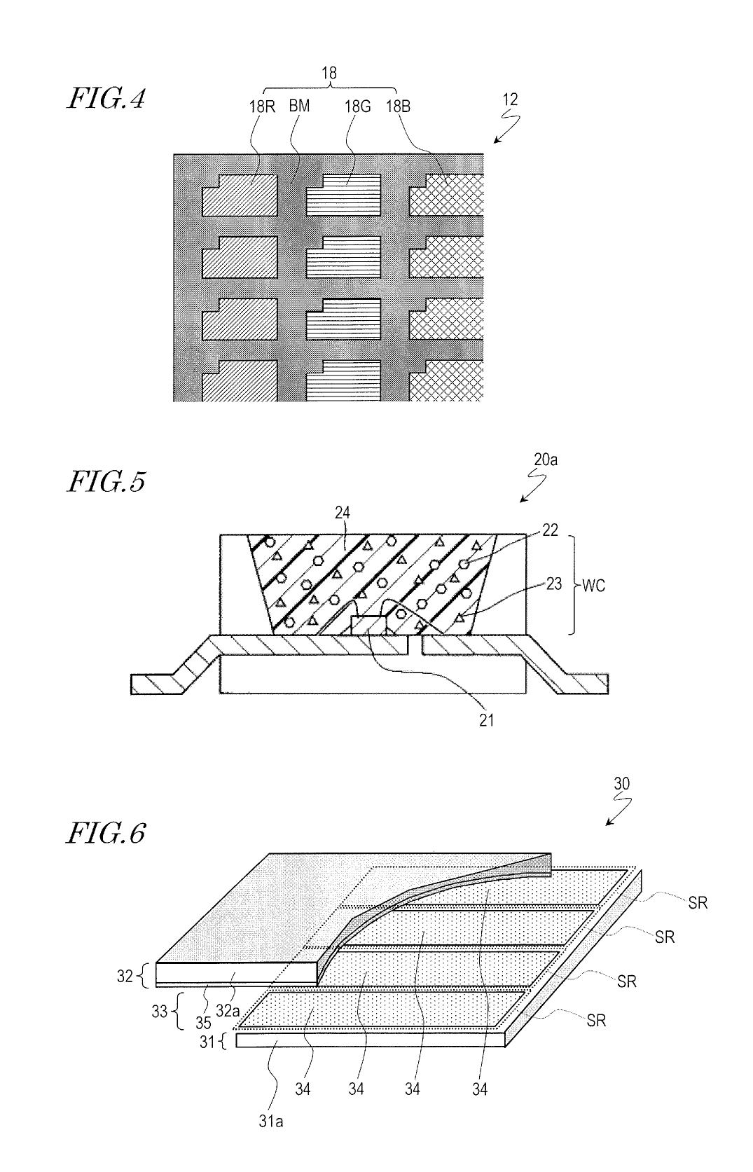

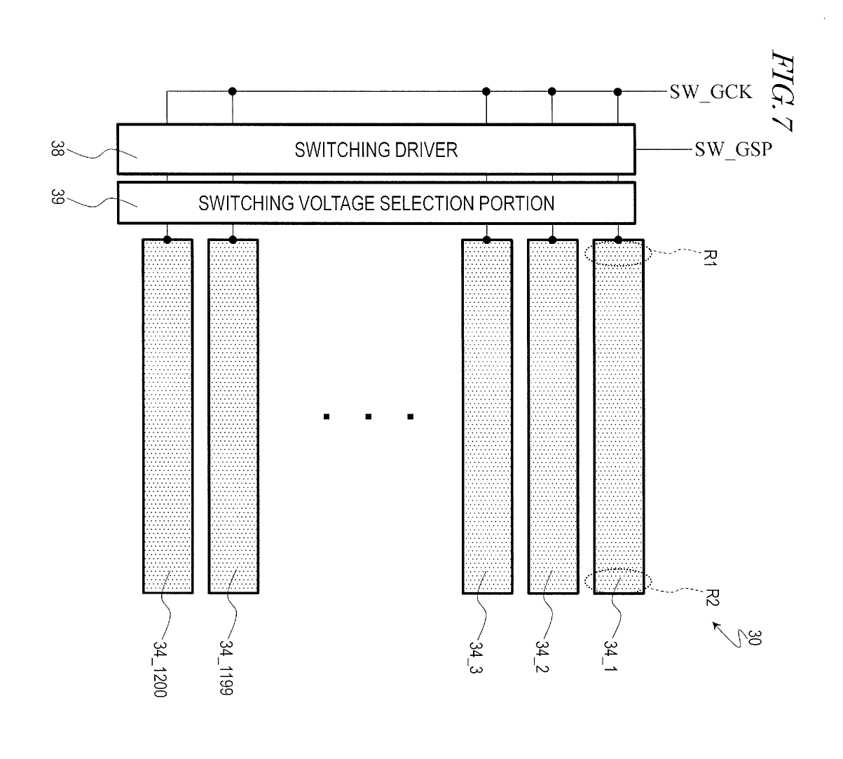

The optical switch panel 30 transmits and blocks light in a switched manner in one vertical scanning period. FIG. 6 shows a specific example of structure of the optical switch panel 30.

As shown in FIG. 6, the optical switch panel 30 includes a first substrate 31 and a second substrate 32 facing each other, and a liquid crystal layer 33 provided between the first substrate 31 and the second substrate 32.

The first substrate 31 includes a plurality of first transparent electrodes (switching electrodes) 34. The plurality of first transparent electrodes 34 are formed of a transparent conductive material (e.g., ITO). The plurality of first transparent electrodes 34 are supported by an insulating transparent substrate (e.g., glass substrate) 31a.

The second substrate 32 includes a second transparent electrode (counter switching electrode) 35. The second transparent electrodes 35 is formed of a transparent conductive material (e.g., ITO). The second transparent electrode 35 is provided to face the plurality of first transparent electrodes 34. The second transparent electrode 35 is supported by an insulating transparent substrate (e.g., glass substrate) 32a.

Liquid crystal molecules contained in the liquid crystal layer 33 have an alignment state thereof changed in accordance with a voltage applied to the liquid crystal layer 33. The first substrate 31 and the second substrate 32 each have an alignment film (not shown) provided on a surface thereof facing the liquid crystal layer 33.

The optical switch panel 30 includes a plurality of switching regions SR each switchable between a light transmitting state and a light blocking state. In FIG. 5, an outer edge of each of the switching regions SR is represented by the dotted line on the first substrate 31. Either one of the plurality of first transparent electrodes 34 is located on each of the plurality of switching regions SR.

In this embodiment, the plurality of switching regions SR each correspond to a region, in a display region of the liquid crystal display panel 10, that is scanned in one horizontal scanning period (hereinafter, such a region may be referred to as a “1H region”). Typically in the liquid crystal display panel 10, one pixel row is scanned in one horizontal scanning period. Therefore, each switching region SR typically corresponds to one pixel row.

The second polarizer plate 40b and the third polarizer plate 40c are located in, for example, a crossed Nicols state or a parallel Nicols state. Namely, the second polarizer plate 40b and the third polarizer plate 40c have polarization axes (transmission axes) perpendicular to each other or parallel to each other.

The liquid crystal layer 33 in each switching region SR may exhibit a state where the polarization direction of light transmitted through the third polarization plate 40c and incident on the liquid crystal layer 33 is not changed, and a state where the polarization direction of light transmitted through the third polarization plate 40c and incident on the liquid crystal layer 33 is changed by 90 degrees, in a switched manner in accordance with the applied voltage (potential difference between the first transparent electrode 34 and the second transparent electrode 35). The liquid crystal layer 33 may change the polarization direction of the incident light by use of optical rotation or by use of birefringence.

FIG. 7 shows a specific example of structure for driving the plurality of first transparent electrodes 34 of the optical switch panel 30. In FIG. 7, the first transparent electrode 34 corresponding to the n'th pixel row is labelled as “34_n”. In the structure shown in FIG. 7, the optical switch panel 30 includes a switching driver (switching electrode driving circuit) 38 and a switching voltage selection portion 39. The switching driver 38 sequentially outputs selection signals based on a switching gate clock signal SW_GCK and a switching gate start pulse SW_GSP. The switching voltage selection portion 39 selects a voltage (potential) for driving the first transparent electrode 34 based on the selection signal that is output from the switching driver 38.

The optical switch panel 30 may have a structure in which each switching region SR is in a light transmitting state when no voltage is applied to the liquid crystal layer 33 (normally white mode) or have a structure in which each switching region SR is in a light blocking state when no voltage is applied to the liquid crystal layer 33 (normally black mode).

The liquid crystal display device 100 in this embodiment includes the optical switch panel 30 transmitting and blocking light in a switched manner in one vertical scanning period. Therefore, impulse-type display is provided while the backlight unit 20 is kept on (namely, with no need to flicker the backlight unit 20). For this reason, no afterimage caused by the high color rendering white LED 20a is generated, and thus the moving image display performance is improved. Namely, high quality moving image display and a broad color reproduction range are both provided.

In the liquid crystal display device 100 in this embodiment, each of the plurality of switching regions SR corresponds to a region, in the display region of the liquid crystal display panel 10, that is scanned in one horizontal scanning period (1H region). Therefore, impulse-type display may be provided with a 1H region as a unit. This provides a high effect of improving the moving image display performance.

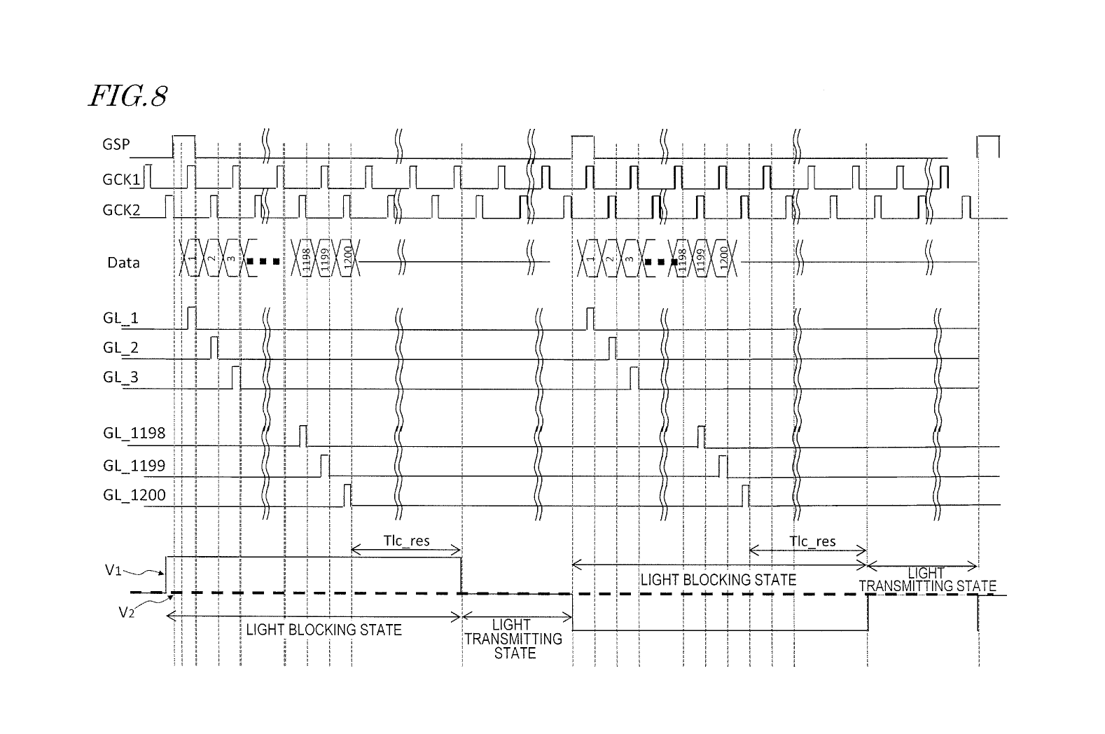

Now, a method for driving the liquid crystal display device 100 will be described in more detail. FIG. 8 is a timing diagram of the driving on the liquid crystal display panel 10 and the driving on the optical switch panel 30. In the example shown in FIG. 8, the optical switch panel 30 is of a normally white mode. FIG. 8 shows a case where the plurality of switching regions SR are switched between the light transmitting state and the light blocking state at the same timing (namely, a case where the impulse driving is performed with the entirety of the display region as a unit), for simpler illustration.

In the liquid crystal display panel 10, the scanning line driving circuit 16 responses to the gate start pulse GSP to sequentially output a scanning signal (gate driving signal) to the scanning lines GS_1, GS_2, GS_3, . . . , GL_1198, GS_1199 and GS_1200 in synchronization with the gate clock signals GCK1 and GCK2. The signal line driving circuit 17 sequentially outputs a display signal Data to the signal lines SL. The pixels are each supplied with the display signal Data (a voltage is applied to the liquid crystal layer 13) at the timing when the TFT 15 is turned on by the scanning signal. The pixel voltage is kept at the same level in a time period after the TFT 15 is turned off until the TFT 15 is turned on again.

In the optical switch panel 30, for a certain time period after the start of one vertical scanning period, potential V₁ of the first transparent electrode 34 and potential V₂ of the second transparent electrode 35 are different from each other and each switching region SR is in a light blocking state. In this state, light emitted from the backlight unit 20 is blocked by the optical switch panel 30. Therefore, the image written to the liquid crystal display panel 10 is not displayed. When a pixel voltage is applied to a pixel connected to the final scanning line GL_1200 and the response of the liquid crystal layer 33 in accordance with the pixel voltage is finished (the time required for this, namely, the liquid crystal response time period, is represented as “Tlc_res” in FIG. 8), potential V₁ of the first transparent electrode 34 is changed to be equal to the potential V₂ of the second transparent electrode 35, and each switching region SR is put into a light transmitting state. In this state, light emitted from the backlight unit 20 is transmitted through the optical switch panel 30. Therefore, the image written to the liquid crystal display panel 10 is displayed. Potential V₁ of the first transparent electrode 34 is changed such that the voltage applied to the liquid crystal layer 33 in a light blocking state in one vertical scanning period and the voltage applied to the liquid crystal layer 33 in a light blocking state in the next vertical scanning period are of opposite polarities.

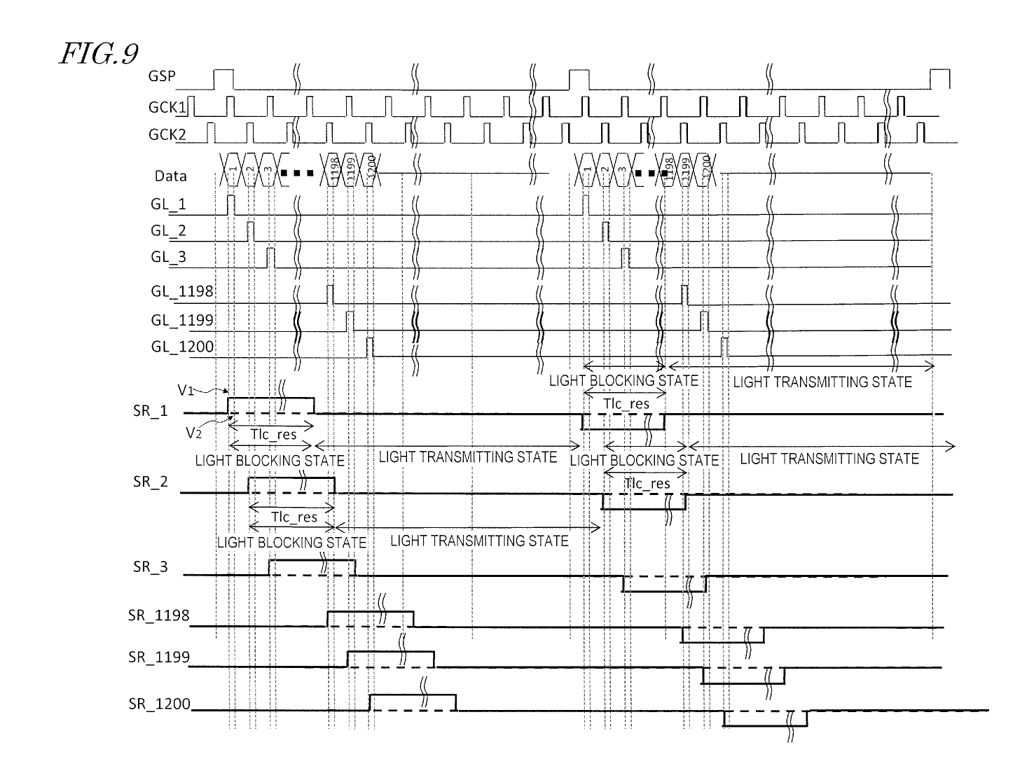

FIG. 9 shows another example of timing diagram of the driving on the liquid crystal display panel 10 and the driving on the optical switch panel 30. FIG. 9 shows a case where the plurality of switching regions SR are switched between the light transmitting state and the light blocking state at different timings (namely, a case where the impulse driving is performed with a 1H region as a unit). In FIG. 9, the switching region SR corresponding to the n'th pixel row is labelled as “SR_n”.

In the example shown in FIG. 9, each switching region SR is in a light blocking state for a lapse of the liquid crystal response time period Tlc_res after a pixel voltage is supplied to the pixels in each pixel row. The switching regions SR_1, SR_2, SR_3, . . . , SR_1198, SR_1199 and _1200 corresponding to the first, second, third, . . . , 1198th, 1199th and 1200th pixel rows are sequentially put into a light transmitting state after a lapse of the corresponding liquid crystal response time period Tlc_res. Therefore, the images written to the liquid crystal display panel 10 are sequentially displayed pixel row by pixel row.

As described above, the liquid crystal display device 100 includes the optical switch panel 30 and thus provides impulse-type display with no need to flicker the backlight unit 20.

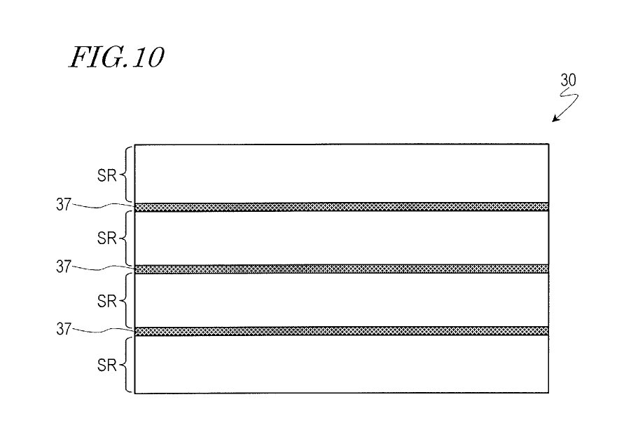

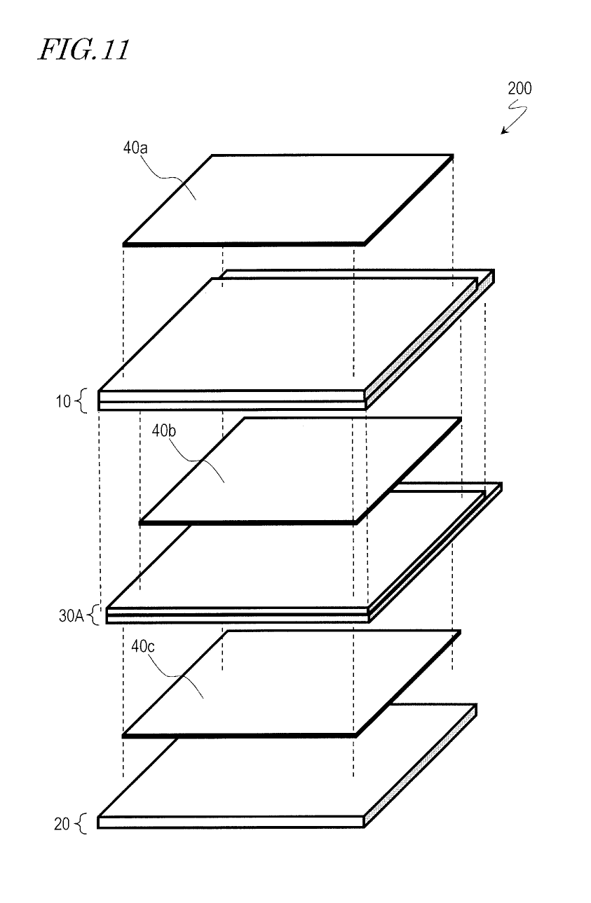

As shown in FIG. 10, the second substrate 32 of the optical switch panel 30 may have a light blocking layer 37 provided between each two switching regions SR adjacent to each other among the plurality of switching regions SR. The light blocking layers 37 thus provided prevent light from leaking due to unstable alignment state between the switching region SR in a light transmitting state and the switching region SR in a light blocking state.

The optical switch panel 30 does not need to include the liquid crystal layer 33 (namely, the optical switch panel 30 does not need to be a liquid crystal panel). For example, the optical switch panel 30 may include a plurality of MEMS shutters. In this case, at least one of the plurality of MEMS shutters is located in each of the plurality of switching regions SR. The MEMS shutters may be any of various known MEMS shutters.

### Embodiment 2

FIG. 11 shows a liquid crystal display device 200 in this embodiment. FIG. 11 is an exploded isometric view schematically showing the liquid crystal display device 200.

As shown in FIG. 11, the liquid crystal display device 200 includes the liquid crystal display panel 10, the backlight unit 20, and an optical switch panel 30A. The liquid crystal display device 100 further includes the first polarizer plate 40a, the second polarizer plate 40b, and the third polarizer plate 40c. The optical switch panel 30A in the liquid crystal display device 200 has a structure different from that of the optical switch panel 30 in embodiment 1.

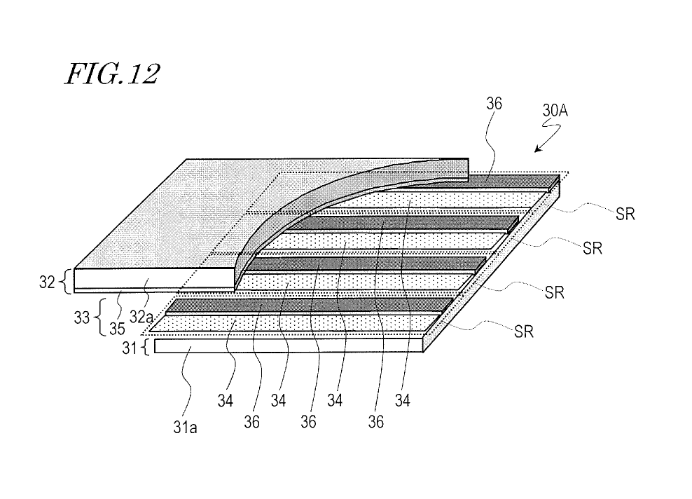

FIG. 12 shows the optical switch panel 30A included in the liquid crystal display device 200. Hereinafter, differences of the optical switch panel 30A from the optical switch panel 30 in embodiment 1 will be mainly described.

In the optical switch panel 30A shown in FIG. 12, the first substrate 31 includes the plurality of first transparent electrodes 34 and also a plurality of metal lines 36 formed of a metal material. The plurality of metal lines 36 are each electrically connected with either one of the plurality of first transparent electrodes 34 (more specifically, a corresponding first transparent electrode 34), and each act as a switching gate bus line supplying a predetermined voltage to the corresponding first transparent electrode 34.

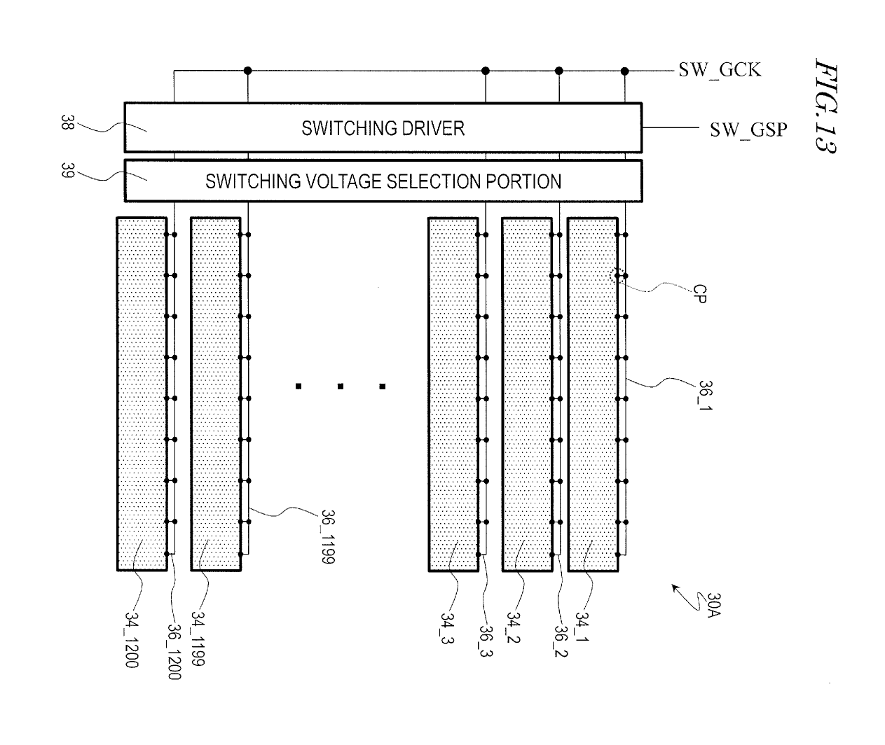

FIG. 13 shows a specific example of structure for driving the plurality of first transparent electrodes 34 of the optical switch panel 30A. In FIG. 13, the first transparent electrode 34 corresponding to the n'th pixel row is labelled as “34-n”. The n'th metal line 36 from the uppermost metal line 36 is labelled as “36-n”. In the structure shown in FIG. 13, the optical switch panel 30 includes the switching driver (switching electrode driving circuit) 38 and the switching voltage selection portion 39. The plurality of first transparent electrodes 34 are each electrically connected with the switching voltage selection portion 39 via the corresponding metal line 36. The switching driver 38 sequentially outputs selection signals based on the switching gate clock signal SW_GCK and the switching gate start pulse SW_GSP. The switching voltage selection portion 39 selects a voltage (potential) for driving the first transparent electrode 34 based on the selection signal that is output from the switching driver 38.

In the liquid crystal display device 200 in this embodiment, the first substrate 31 in the optical switch panel 30A includes the metal lines 36, and therefore, the light transmission and the light blocking are performed more preferably by the optical switch panel 30A. Hereinafter, a reason for this will be described.

In general, the resistance value of a conductive layer formed of a transparent conductive material such as ITO or the like is likely to be higher than the resistance value of a conductive layer formed of a metal material. This will be described regarding the sheet resistance. The sheet resistance of a conductive layer formed of ITO is about 50 times the sheet resistance of a conductive layer formed of a metal material. Therefore, the first transparent electrodes 34 are likely to have a high resistance value. The first transparent electrodes 34 each have such a size as to overlap at least a 1H region, and therefore, are also likely to have a high parasitic capacitance. For example, one pixel of a 5-inch FHD liquid crystal display panel has a size of about 57 μm×57 μm, and thus each first transparent electrode 34 has a length of about 62 to 63 mm.

As described above, the resistance value and the parasitic capacitance of the first transparent electrode 34 are likely to be high. Therefore, with the structure of the optical switch panel 30 in embodiment 1 (see FIG. 7), an end R1 of the first transparent electrode 34 on the side of the switching voltage selection portion 39 and an end R2 of the first transparent electrode 34 on the opposite side have different manners of voltage change. For this reason, liquid crystal molecules in the liquid crystal layer 33 above the end R1 and the end R2 are aligned in different manners from each other. This may undesirably cause variance in the light transmittance in each of the switching regions SR.

By contrast, in this embodiment, the metal lines 36 electrically connected with the first transparent electrodes 34 are provided. Therefore, the line resistance of the switching electrode (herein, each first transparent electrode 34 and each metal line 36 electrically connected with the each first transparent electrode 34 may be collectively considered as a switching electrode) is decreased, and thus the voltage is changed uniformly in the entirety of each first transparent electrode 34. This suppresses variance in the light transmittance in each switching region SR, and the light transmission and the light blocking are performed more preferably by the optical switch panel 30A.

It is preferable that one of the metal lines 36 and the first transparent electrode 34 corresponding thereto are connected with each other at two or more connection portions CP (see FIG. 13). It is preferable that the connection portions CP are provided at a cycle equal to the pixel pitch of the liquid crystal display panel 10 or a shorter. In the example shown in FIG. 12, each of the metal lines 36 is provided to cover a part of the corresponding first transparent electrode 34. The metal line 36 is continuously in contact with the first transparent electrode 34 along a direction of the pixel row. Therefore, in this example, it is considered that there are an infinite number of connection portions CP.

It is preferable that the connection portions CP between the plurality of metal lines 36 and the plurality of first transparent electrodes 34 are located to cover the black matrix BM of the liquid crystal display panel 10. It is also preferable that the plurality of metal lines 36 themselves are located to overlap the black matrix BM of the liquid crystal display panel 10.

There is no specific limitation on the metal material usable to form the plurality of metal materials 36. In order to realize a minimum possible line resistance, it is preferable to use, for example, aluminum (Al) or copper (Cu). The metal lines 36 may each be a multi-layer line having a stack structure including a layer formed of Al or Cu and a layer formed of titanium (Ti), tungsten (W) or molybdenum (Mo). There is no specific limitation on the width or the thickness of each of the metal lines 36. The width or the thickness of each of the metal lines 36 may be set so as to realize a desired line resistance value.

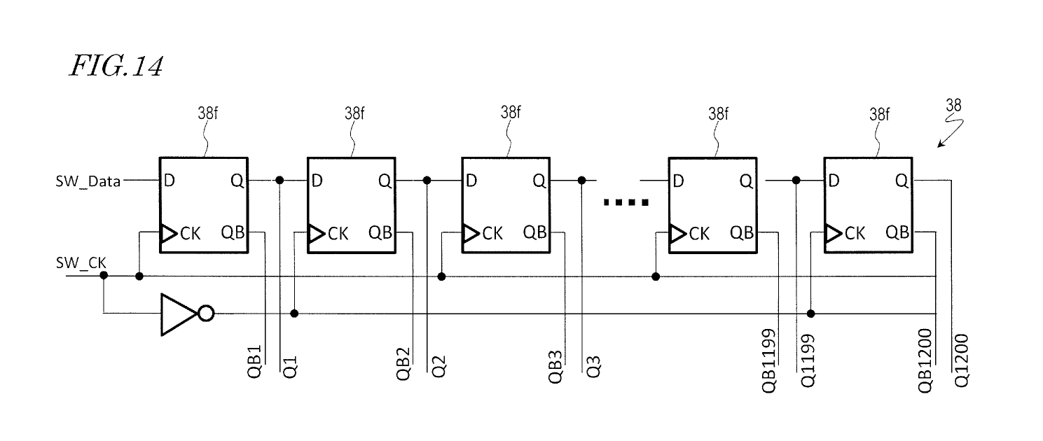

FIG. 14 shows a specific example of structure of the switching driver 38. In the example shown in FIG. 14, the switching driver 38 includes a plurality of flip-flops 38f. Each of the flip-flops 38f includes an input terminal D, a clock terminal CK, an output terminal Q and an inverted output terminal QB.

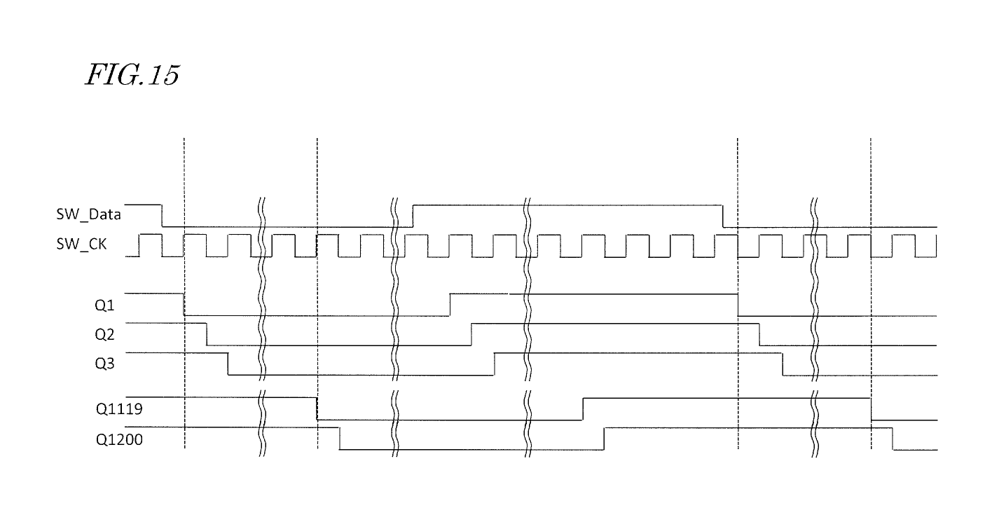

FIG. 15 is a timing diagram of the switching driver 38. As shown in FIG. 14 and FIG. 15, the switching driver 38 outputs signals Q1, Q2, Q3, . . . , Q1199, A1200 and inverted signals thereof QB1, QB2, QB3, . . . , QB1199 and QB1200 (the inverted signals are not shown in FIG. 15) based on an input switching data signal SW_Data and an input switching clock signal SW_CK.

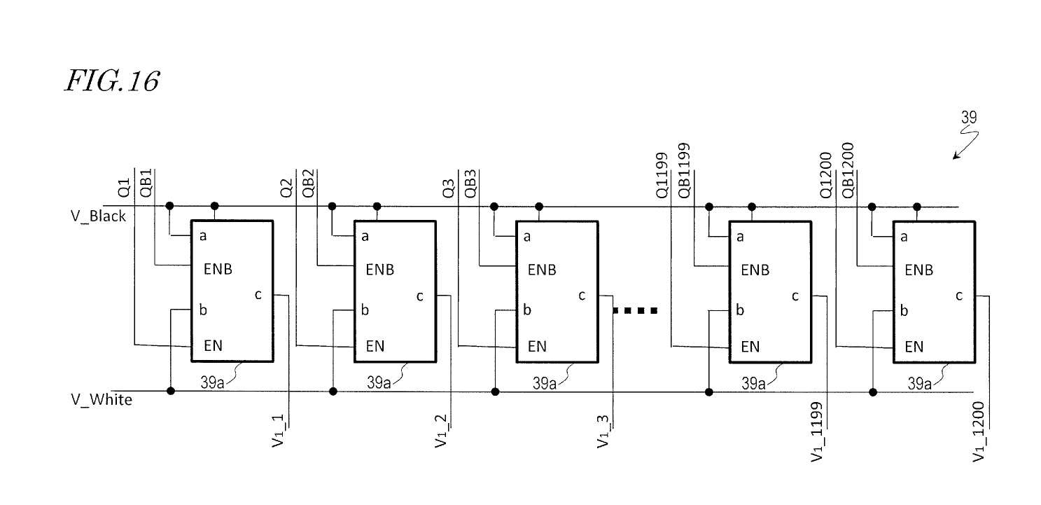

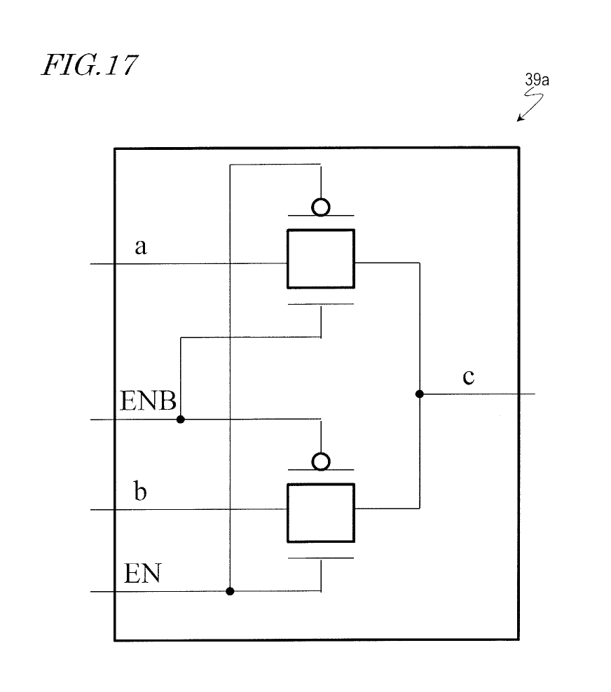

FIG. 16 shows a specific example of structure of the switching voltage selection portion 39. In the example shown in FIG. 39, the switching voltage selection portion 39 includes a plurality of switching voltage selectors 39a. As shown in FIG. 17, each of the switching voltage selectors 39a includes an analog switch. Based on an input selection signal EN and an input inverted signal thereof ENB, the switching voltage selector 39a selects a signal a or a signal b separately input thereto and outputs the selected signal as a signal c.

FIG. 18 is a timing diagram of the switching voltage selection portion 39. The selection signal EN and the inverted signal thereof ENB that are input to the switching voltage selector 39a are the signals Q1, Q2, Q3, . . . , Q1199, Q1200 and the inverted signals thereof QB1, QB2, QB3, . . . , QB1199 and QB1200 that are output from the switching driver 38. The signal a and the signal b input to the switching voltage selector 39a are respectively a light blocking voltage V_Black (voltage for black) for realizing a light blocking state (“Bl” in FIG. 18) and a light transmitting voltage V_White (voltage for black) for realizing a light transmitting state (“W” in FIG. 18). The signal c output from the switching voltage selector 39a is a voltage (potential) V₁ given to the first transparent electrode 34.

As shown in FIG. 18, the signals Q1, Q2, Q3, . . . , Q1199, Q1200 and the inverted signals thereof QB1, QB2, QB3, . . . , QB1199 and QB1200 (the inverted signals are not shown in FIG. 18) output from the switching driver 38 are input to the switching voltage selection portion 39. Based on these signals and inverted signals, the switching voltage selection portion 39 outputs the voltage for black V_Black or the voltage for white V_White to the plurality of first transparent electrodes 34_1, 34_2, 34_3, . . . , 34_1199 and 34_1200 as the voltages V₁_{_}1, V₁_{_}2, V₁_{_}3, . . . , V₁_{_}1199 and V₁_{_}1200. At this point, the voltage V₂ of the second transparent electrode 35 is of an equal level to that of the voltage for white V_White.

In the above-described example, each of the switching regions SR corresponds to a 1H region (region, in the display region of the liquid crystal display panel 10, that is scanned in one horizontal scanning period). Each of the switching regions SR does not need to correspond to a 1H region, and may correspond to a region, in the display region of the liquid crystal display panel 10, that is scanned in two or more horizontal scanning periods.

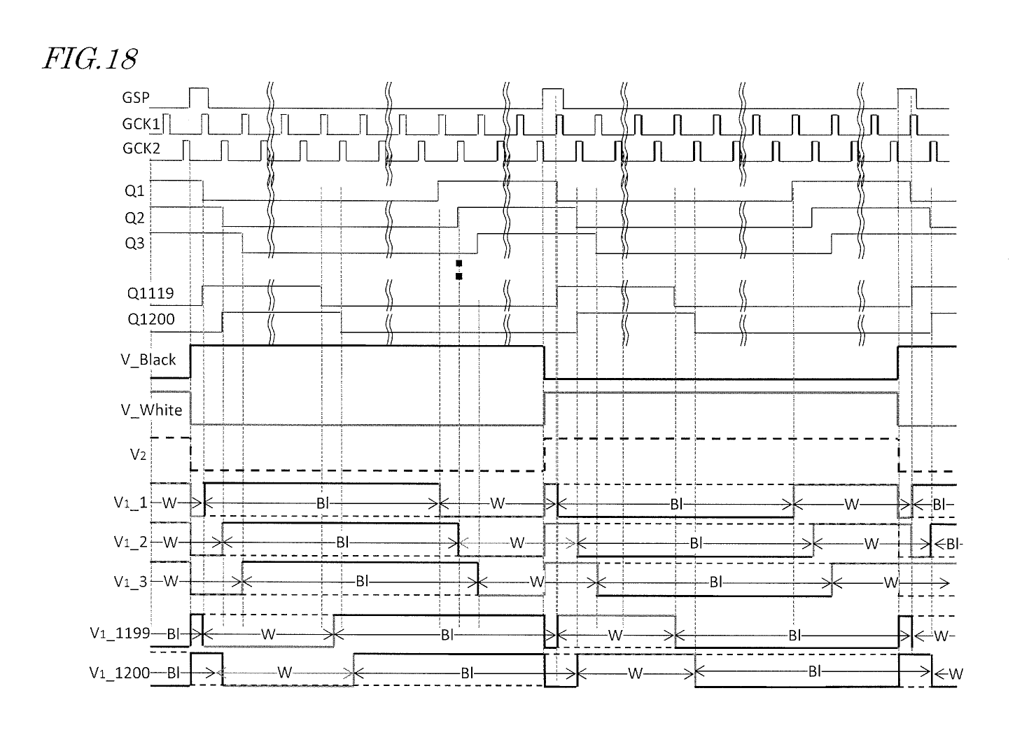

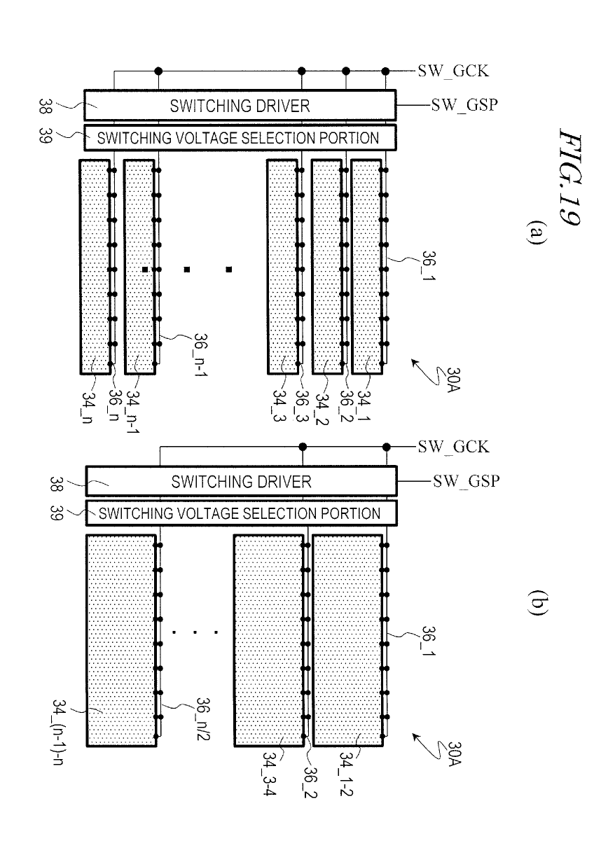

FIG. 19(a) shows a structure in the case where each of the switching regions SR corresponds to a 1H region, and FIG. 19(b) shows a structure in the case where each of the switching regions SR corresponds to a region, in the display region of the liquid crystal display panel 10, that is scanned in two horizontal scanning periods (hereinafter, such a region will be referred to as a “2H region”).

In the structure shown in FIG. 19(a), each of the plurality of first transparent electrodes 34 has a size corresponding to one pixel row, and the first transparent electrode 34_n corresponding to the n'th pixel row is electrically connected with the n'th metal line 36_n.

By contrast, in the structure shown in FIG. 19(b), each of the plurality of first transparent electrodes 34 has a size corresponding to two pixel rows. The transparent electrode 34_(n−1)-n corresponding to the (n−1)th and n'th pixel rows is electrically connected with the n/2'th metal line 36_n/2.

As described above, each of the switching regions SR may correspond to a region, in the display region of the liquid crystal display panel 10, that is scanned in M horizontal scanning periods (M is an integer of 2 or greater) (namely, 2H or greater region). In this case, the first substrate 31 of the optical switch panel 30A may include dummy lines described below.

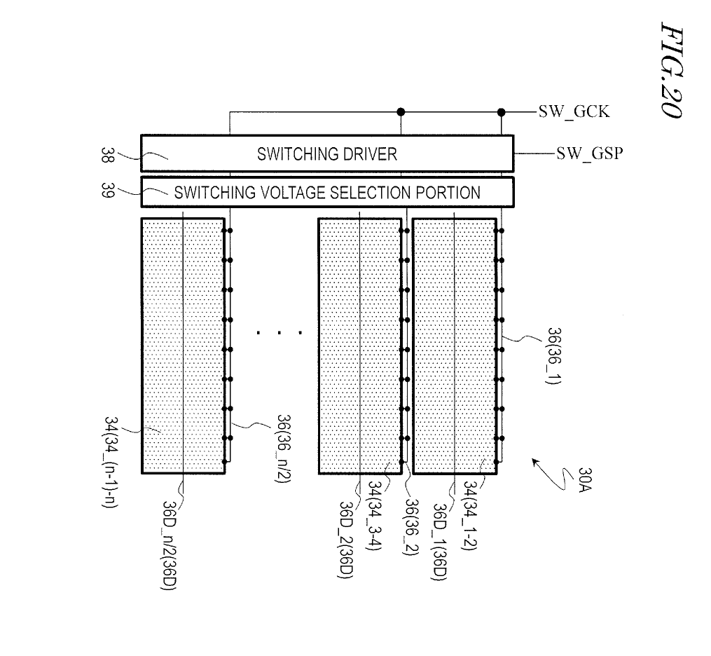

FIG. 20 shows an example of structure of the optical switch panel 30A including a plurality of dummy lines 36D (in FIG. 20, first, second, . . . , n/2'th dummy lines 36D are respectively labelled as “36D_1”, “36D_2”, . . . , “36D_n/2”). In the example shown in FIG. 20, each of the switching regions SR corresponds to a 2H region.

The plurality of dummy lines 36D are not electrically connected with the plurality of first transparent electrodes 34. At least one (in this example, one) dummy line 36D is located between each two adjacent metal lines 36 among the plurality of metal lines 36. In this example, the number of the plurality of dummy lines 36D is equal to the number of the plurality of metal lines 36 (namely, the number of the dummy lines 36D is one time the number of the metal lines 36). Each of the dummy lines 36D has a width substantially equal to that of each metal line 36.

The first dummy line 36D_1 is located to be at a center, in the width direction, of the first transparent electrode 34_1-2 corresponding to the first and second pixel rows. Namely, the first dummy line 36D_1 is provided in a region corresponding to a region between the first pixel row and the second pixel row. The second dummy line 36D_2 is located to be at a center, in the width direction, of the first transparent electrode 34_3-4 corresponding to the third and fourth pixel rows. Namely, the second dummy line 36D_2 is provided in a region corresponding to a region between the third pixel row and the fourth pixel row. The third dummy line 36D and thereafter are provided in the same manner.

In the case where the above-described dummy lines 36D are not provided, for example, no metal line 36 is located in a region corresponding to a region between the first pixel row and the second pixel row; whereas the metal line 36 (36_2) is located in a region corresponding to a region between the second pixel row and the third pixel row. Therefore, in the light transmitting state, the region corresponding to the region between the first pixel row and the second pixel row transmits light, whereas the region corresponding to the region between the second pixel row and the third pixel row blocks light. In this case, these two regions are seen differently, and thus horizontal stripes may be undesirably visually recognized.

By contrast, in the case where the plurality of dummy lines 36D are provided in the first substrate 31, the above-described problem (horizontal stripes) is prevented. The plurality of dummy lines 36D may be in an electrically floating state or may be supplied with a potential equal to the potential V₂ of the second transparent electrode 35.

In the above-described example, each of the switching regions SR corresponds to a 2H region. In the case where each of the switching regions SR corresponds to a 3H or greater region, the plurality of dummy lines 36D may be located to provide substantially the same effect. In the case where, for example, each of the switching regions SR corresponds to a 3H region, the dummy lines 36D may be provided in a number that is twice the number of the plurality of metal lines 36. Namely, in the case where each of the switching regions SR corresponds to a region that is scanned in an M horizontal scanning period (M is an integer of 2 or greater), the first substrate 31 may include the dummy lines 36D in a number that is (M−1) times the number of the plurality of metal lines 36.

In the above-described examples, the plurality of first transparent electrodes 34 of the optical switch panel 30 (30A) are sequentially driven. It is conceivable that like in the case where the liquid crystal display panel 10 is interface-driven, odd number pixel rows are first driven in a half or shorter period of one vertical scanning period, and then even number pixel rows are driven in the remaining time period (a half or shorter period of one vertical scanning period). In this case, a structure shown in FIG. 21 may be adopted.

In the structure shown in FIG. 21, the switching driver 38 and the switching voltage selection portion 39 are provided on the left side and also on the right side of the region corresponding to the display region (region where the plurality of first transparent electrodes 34 are provided). The switching driver 38 and the switching voltage selection portion 39 provided on the left side act as an odd number pixel row driver Dodd driving the first transparent electrodes 34 corresponding to the odd number pixel rows based on a switching gate clock signal SW_GCK_odd and a switching gate start pulse SW_GSP_odd. The switching driver 38 and the switching voltage selection portion 39 provided on the right side act as an even number pixel row driver Deven driving the first transparent electrodes 34 corresponding to the even number pixel rows based on a switching gate clock signal SW_GCK_even and a switching gate start pulse SW_GSP_even. In this structure, after the first transparent electrodes 34 corresponding to the odd number pixel rows are sequentially driven in an ascending order by the odd number pixel row driver Dodd, the first transparent electrodes 34 corresponding to the even number pixel rows are sequentially driven in an ascending order by the even number pixel row driver Deven.

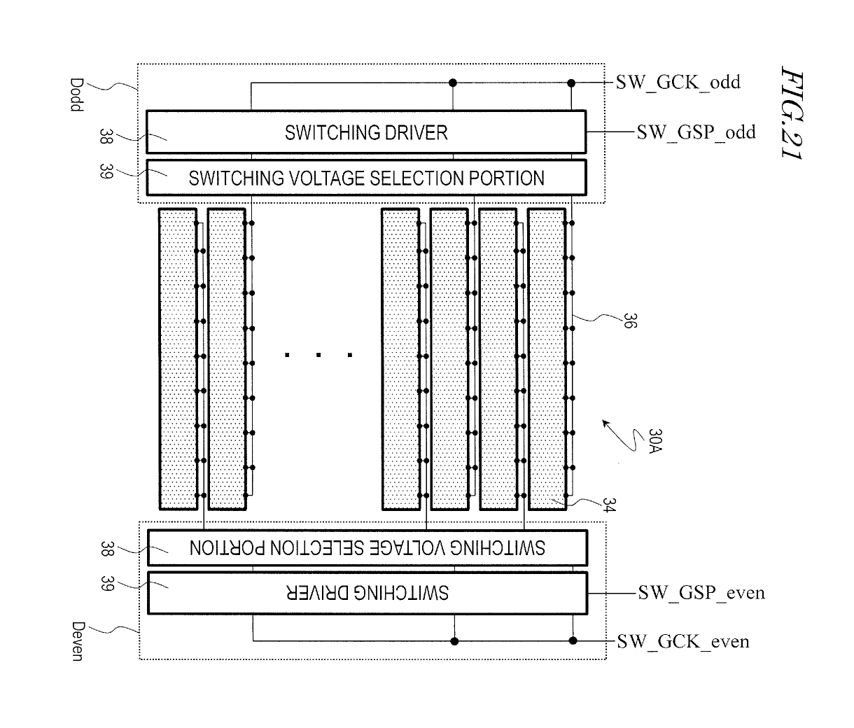

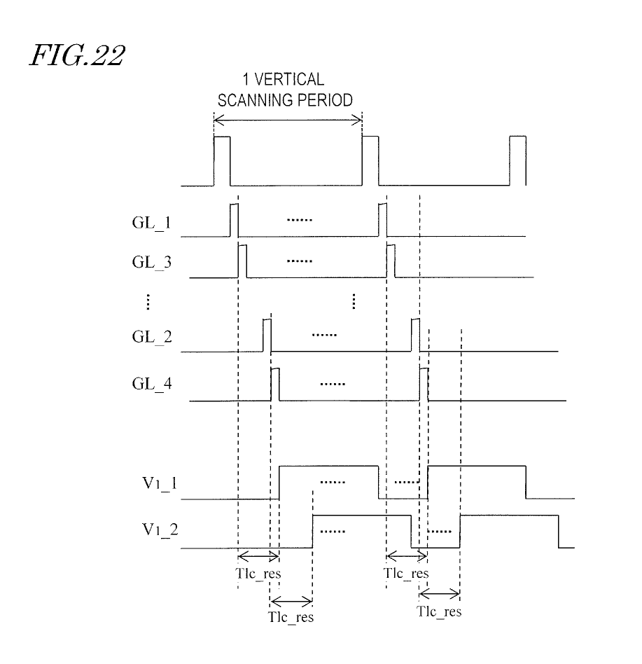

FIG. 22 is a timing diagram in the case where the structure shown in FIG. 21 is adopted. At the start of one vertical scanning period, first, the odd number pixel rows of the liquid crystal display panel 10 are sequentially driven in an ascending order (namely, the scanning lines GL_1, GL_3, . . . , corresponding to the odd number pixel rows are sequentially supplied with an ON voltage). After a lapse of a predetermined response time period Tlc_res after the pixel voltage is supplied to the pixels in the first pixel row, the first transparent electrode 34_1 of the optical switching panel 30A corresponding to the first pixel row is driven to put the corresponding switching region SR into a light transmitting state. Similarly, after a lapse of a predetermined response time period Tlc_res after the pixel voltage is sequentially supplied to the pixels in the third, fifth, . . . pixel rows, the first transparent electrodes 34_3, 34_5, . . . of the optical switching panel 30A corresponding to the third, fifth, . . . pixel rows are sequentially driven to put the corresponding switching regions SR into a light transmitting state. When the scanning on the odd number pixel rows of the liquid crystal display panel 10 is finished, the even number pixel rows are sequentially scanned, and thus the first transparent electrodes 34 of the optical switch panel 30A corresponding to the even number pixel rows are sequentially driven.

Instead of the structure shown in FIG. 21, a structure shown in FIG. 23 may be adopted. In the structure shown in FIG. 23, an odd number switching driver 38odd and an even number switching driver 38even are provided on one side (in this example, on the left side) of the region corresponding to the display region. When the switching gate start pulse SW_GSP is input to the odd number switching driver 38odd, the odd number switching driver 38odd outputs a selection signal in accordance with the switching gate clock signal SW_GCK_odd for the odd number pixel rows. Based on the output selection signal, the switching voltage selection portion 39 selects a voltage for driving the first transparent electrodes 34 to drive the first transparent electrodes 34 corresponding to the odd number pixel rows. When the driving on the odd number pixel rows is finished, the first stage of the even number switching driver 38even is connected, and the even number switching driver 38even outputs a selection signal in accordance with the switching gate clock signal SW_GCK_even for the even number pixel rows. Based on the output selection signal, the switching voltage selection portion 39 selects a voltage for driving the first transparent electrodes 34 to drive the first transparent electrodes 34 corresponding to the even number pixel rows.

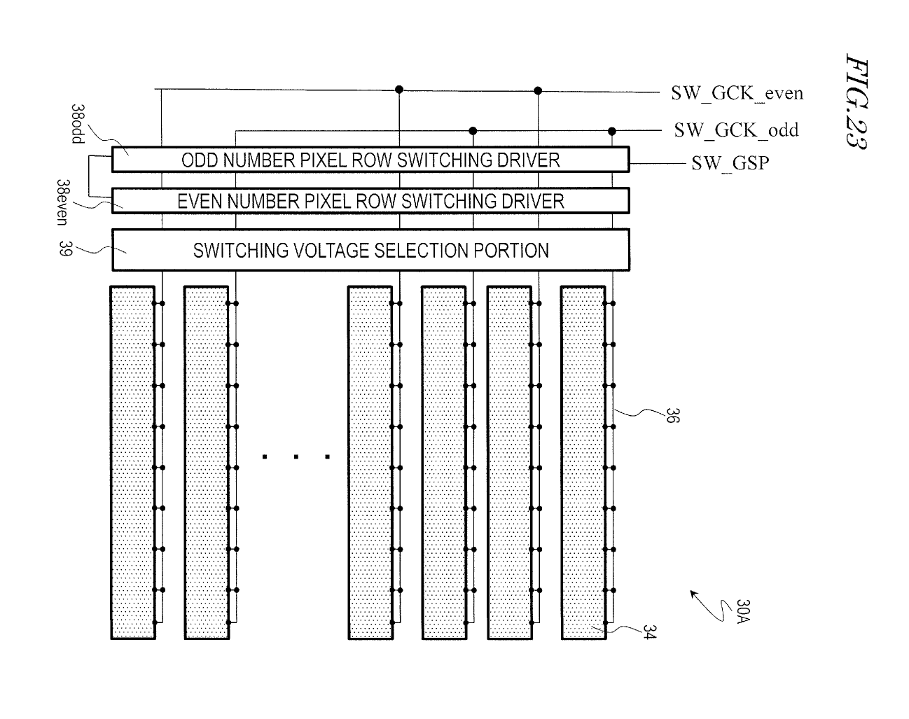

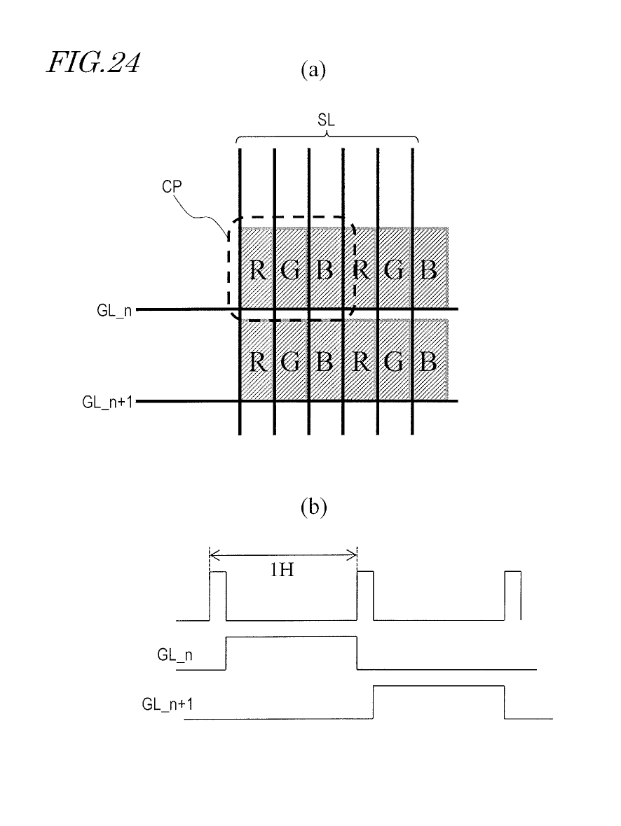

In the above-described examples, a region, in the display region of the liquid crystal display panel 10, that is scanned in one horizontal scanning period (1H region) is one pixel row. FIG. 24(a) shows an example of pixel arrangement in the case where a 1H region is one pixel row. In the example shown in FIG. 24(a), a red pixel R, a green pixel G and a blue pixel B included in one color display pixel CP are arrayed in the row direction (horizontal direction) and are connected with different signal lines SL via the TFTs. As shown in FIG. 24(b), the red pixel R, the green pixel G and the blue pixel B included in one pixel are selected by the common scanning line GL_n and the corresponding signal lines SL write display data to the red pixel R, the green pixel G and the blue pixel B in one horizontal scanning period (1H).

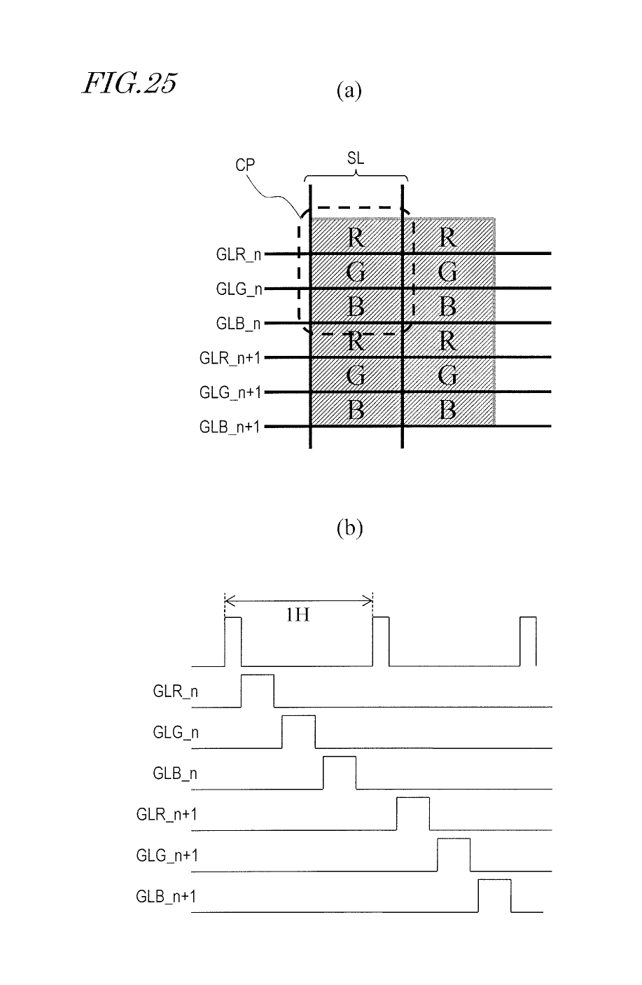

A 1H region does not need to be one pixel row. FIG. 25(a) shows an example of pixel arrangement in the case where a 1H region is three pixel rows. In the example shown in FIG. 25(a), the red pixel R, the green pixel G and the blue pixel B included in one color display pixel CP are arrayed in a column direction (vertical direction) and are connected with the common signal line SL via the TFTs. As shown in FIG. 25(b), the red pixel R, the green pixel G and the blue pixel B included in one pixel are respectively selected by different scanning lines GLR_n, GLG_n and GLB_n and the common signal line SL sequentially writes display data to the red pixel R, the green pixel G and the blue pixel B in one horizontal scanning period (1H).

In the case where each of the color display pixels includes N pixels (N is an integer of 3 or greater) as described above, a 1H region may be one or greater and N or less pixel row(s).

In the above description, as shown in FIG. 1 through FIG. 11, the optical switch panel 30 or 30A is provided between the liquid crystal display panel 10 and the backlight unit 20. An embodiment of the present invention is not limited to having such a structure.

Like in a liquid crystal display device 300 shown in FIG. 26, the optical switch panel 30 (or 30A) may be provided on the observer side of the liquid crystal display panel 10. In the structure shown in FIG. 26, the first polarizer plate 40a is provided on the observer side of the optical switch panel 30 (or 30A), and the second polarizer plate 40b is provided between the optical switch panel 30 (or 30A) and the liquid crystal display panel 10. The third polarizer plate 40c is provided between the liquid crystal display panel 10 and the backlight unit 20.

The liquid crystal display device 300 shown in FIG. 26 includes the optical switch panel 30 transmitting and blocking light in a switched manner in one vertical scanning period. Therefore, impulse-type display is provided while the backlight unit 20 is in an ON state (namely, with no need to flicker the backlight unit 20). For this reason, no red afterimage caused by the high color rendering white LED 20a is generated, and thus the moving image display performance is improved. Namely, high quality moving image display and a broad color reproduction range are both provided.

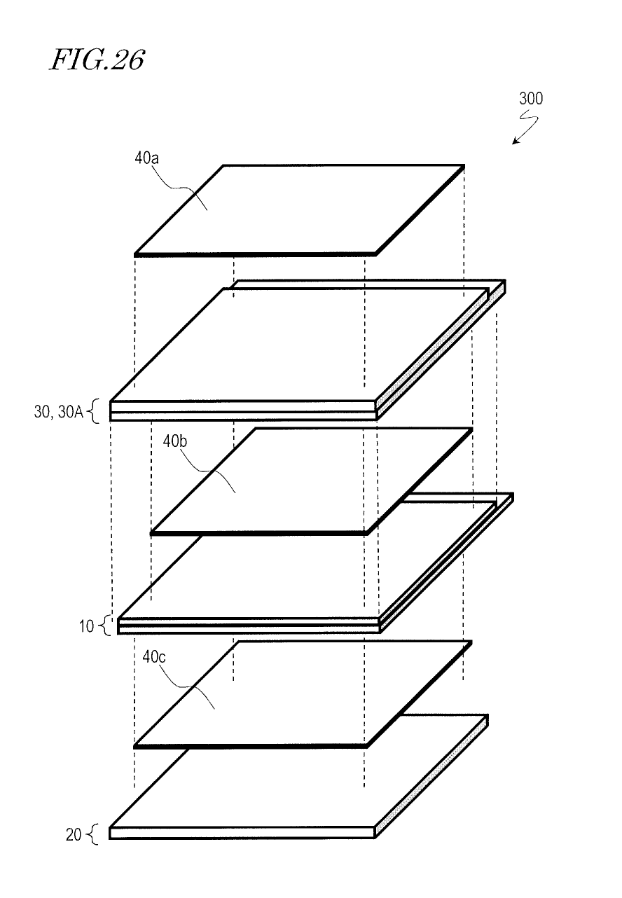

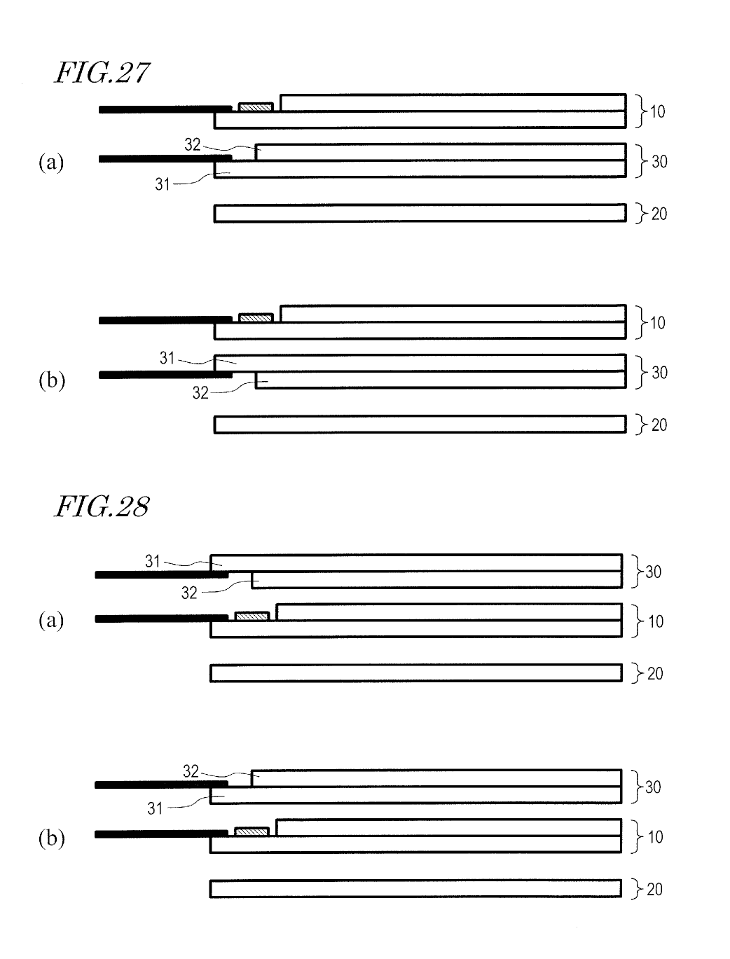

In the case where the optical switch panel 30 (or 30A) is provided between the liquid crystal display panel 10 and the backlight unit 20, the optical switch panel 30 (or 30A) may be located as shown in FIG. 27(a), such that the second substrate 32 is on the side of the liquid crystal display panel 10 (namely, such that the first substrate 31 is located on the side of the backlight unit 20), or may be located as shown in FIG. 27(b), such that the first substrate 31 is on the side of the liquid crystal display panel 30 (namely, such that the second substrate 32 is located on the side of the backlight unit 20).

In the case where the optical switch panel 30 (or 30A) is located on the observer side of the liquid crystal display panel 10, the optical switch panel 30 (or 30A) may be located as shown in FIG. 28(a), such that the second substrate 32 is on the side of the liquid crystal display panel 30 (namely, such that the first substrate 31 is located on the observer side, or may be located as shown in FIG. 28(b), such that the first substrate 31 is on the side of the liquid crystal display panel 30 (namely, such that the second substrate 32 is located on the observer side).

(Specific Examples of Structure of the High Color Rendering White LED)

As the high color rendering white LED 20a, a light emitting device disclosed in Patent Document 4, for example, is usable. The entirety of Patent Document 4 is incorporated therein by reference.

It is preferable that the wavelength conversion portion WC of the white LED 20a includes, as the green phosphor 22, at least one selected from (A) bivalent europium-activated oxide nitride phosphor which is β-type SiAlON, and (B) bivalent europium-activated silicate phosphor. It is preferable that the wavelength conversion portion WC of the white LED 20a includes, as the red phosphor 23, at least one selected from the two types of tetravalent manganese-activated tetravalent metal fluoride salt phosphor (C) and (D). (A), (B), (C) and (D) are shown below.

(A) Bivalent Europium-Activated Oxide Nitride Phosphor which is β-Type SiAlON

A bivalent europium-activated oxide nitride green phosphor preferably usable as the green phosphor 22 is substantially represented by:

EuₐSi_{b}Al_{c}O_{d}Nₑ General formula (A):

(hereafter, this bivalent europium-activated oxide nitride green phosphor will be referred to as a “first green phosphor”). In general formula (A), Eu is europium, Si is silicon, Al is aluminum, O is oxygen, and N is nitrogen.

In general formula (A), the value of “a” representing the composition ratio (concentration) of Eu is 0.005≦a≦0.4. In the case where the value of “a” is less than 0.005, a sufficiently high level of brightness may not be provided. In the case where the value of “a” exceeds 0.4, the brightness may be significantly decreased due to concentration quenching. The value of “a” in the above expression is preferably 0.01≦a≦0.2 from the points of view of the stability of the powder characteristics, the homogeneity of the matrix and the like.

In general formula (A), the value of “b” representing the composition ratio (concentration) of Si and the value of “c” representing the composition ratio (concentration) of Al are numerals fulfilling b+c=12. The value of “d” representing the composition ratio (concentration) of O and the value of “e” representing the composition ratio (concentration) of N are numerals fulfilling d+e=16.

Specific examples of the first green phosphor include Eu_{0.05}Si_{11.50}Al_{0.50}O_{0.05}N_{15.95}, Eu_{0.10}Si_{11.00}Al_{1.00}O_{0.10}N_{15.90}, Eu_{0.30}Si_{9.80}Al_{2.20}O_{0.30}N_{15.70}, Eu_{0.15}Si_{10.00}Al_{2.00}O_{0.20}N_{15.80}, Eu_{0.01}Si_{11.60}Al_{0.40}O_{0.01}N_{15.99}, Eu_{0.005}Si_{11.70}Al_{0.30}O_{0.03}N_{15.97}, and the like. The first green phosphor is not limited to any of these, needless to say.

(B) Bivalent Europium-Activated Silicate Phosphor

A bivalent europium-activated silicate green phosphor preferably usable as the green phosphor 22 is substantially represented by:

2(Ba_{1-f-g}MI_{f}Eu_{g})O.SiO₂ General formula (B):

(hereafter, this bivalent europium-activated silicate green phosphor will be referred to as a “second green phosphor”). In general formula (B), Ba is barium, Eu is europium, O is oxygen, and Si is silicon. In general formula (B), MI is at least one alkaline earth metal element selected from Mg, Ca and Sr. In order to provide a highly efficient matrix, MI is preferably Sr.

In general formula (B), the value of “f” representing the composition ratio (concentration) of MI is 0<f≦0.55. The value of “f” is in this range, so that the green-type light of a wavelength in the range of 510 to 540 mm is emitted. In the case where the value of “f” exceeds 0.55, the green-type light is yellowish, and the color purity is decreased. The value of “f” is preferably in the range of 0.15≦f≦0.45 from the points of view of the efficiency and the color purity.

In general formula (B), the value of “g” representing the composition ratio (concentration) of Eu is 0.03≦g≦0.10. In the case where the value of “g” is less than 0.03, a sufficiently high level of brightness may not be provided. In the case where the value of “g” exceeds 0.10, the brightness may be significantly decreased due to concentration quenching. The value of “g” is preferably in the range of 0.04≦g≦0.08 from the points of view of the brightness and the stability of the powder characteristics.

Specific examples of the second green phosphor include 2(Ba_{0.70}Sr_{0.26}Eu_{0.04}).SiO₂, 2(Ba_{0.57}Sr_{0.38}Eu_{0.05})O.SiO₂, 2(Ba_{0.53}Sr_{0.43}Eu_{0.04})O.SiO₂, 2(Ba_{0.82}Sr_{0.15}Eu_{0.03})O.SiO₂, 2(Ba_{0.46}Sr_{0.49}Eu_{0.05})O.SiO₂, 2(Ba_{0.59}Sr_{0.35}Eu_{0.06})O.SiO₂, 2(Ba_{0.52}Sr_{0.40}Eu_{0.08})O.SiO₂, 2(Ba_{0.85}Sr_{0.10}Eu_{0.05})O.SiO₂, 2(Ba_{0.47}Sr_{0.50}Eu_{0.03})O.SiO₂, 2(Ba_{0.54}Sr_{0.36}Eu_{0.10})O.SiO₂, 2(Ba_{0.69}Sr_{0.25}Ca_{0.02}Eu_{0.04})O.SiO₂, 2(Ba_{0.56}Sr_{0.38}Mg_{0.01}Eu_{0.05})O.SiO₂, 2(Ba_{0.81}Sr_{0.13}Mg_{0.01}Ca_{0.02}Eu_{0.04})O.SiO₂, and the like. The second green phosphor is not limited to any of these, needless to say.

(C) Tetravalent Manganese-Activated Tetravalent Metal Fluoride Salt Phosphor

A tetravalent manganese-activated tetravalent metal fluoride salt phosphor preferably usable as the red phosphor 23 is substantially represented by:

MII₂(MIII₁₋ₕMnₕ)F₆ General formula (C):

(hereafter, this tetravalent manganese-activated tetravalent metal fluoride salt phosphor will be referred to as a “first red phosphor”). In general formula (C), Mn is manganese and F is fluorine. In general formula (C), MII is at least one alkaline metal element selected from Na, K, Rb and Cs. From the points of view of the brightness and the stability of the powder characteristics, MII is preferably K. In general formula (C), MIII is at least one tetravalent metal element selected from Ge, Si, Sn, Ti and Zr. From the points of view of the brightness and the stability of the powder characteristics, MIII is preferably Ti.

In general formula (C), the value of “h” representing the composition ratio (concentration) of Mn is 0.001≦h≦0.1. In the case where the value of “h” is less than 0.001, a sufficiently high level of brightness may not be provided. In the case where the value of “h” exceeds 0.1, the brightness may be significantly decreased due to concentration quenching. The value of “h” is preferably 0.005≦h≦0.5 from the points of view of the brightness and the stability of the powder characteristics.

Specific examples of the first red phosphor include K₂(Ti_{0.99}Mn_{0.01})F₆, K₂(Ti_{0.9}Mn_{0.1})F₆, K₂(Ti_{0.999}Mn_{0.001})F₆, Na₂(Zr_{0.98}Mn_{0.02})F₆, Cs₂(Si_{0.95}Mn_{0.05})F₆, Cs₂(Sn_{0.98}Mn_{0.02})F₆, K₂(Ti_{0.88}Zr_{0.10}Mn_{0.02})F₆, Na₂(Ti_{0.75}Sn_{0.20}Mn_{0.05})F₆, Cs₂(Ge_{0.999}Mn_{0.001})F₆, (K_{0.80}Na_{0.20})₂(Ti_{0.69}Ge_{0.30}Mn_{0.01})F₆, and the like. The first red phosphor is not limited to any of these, needless to say.

(D) Tetravalent Manganese-Activated Tetravalent Metal Fluoride Salt Phosphor

A tetravalent manganese-activated tetravalent metal fluoride salt phosphor preferably usable as the red phosphor 23 is substantially represented by:

MIV(MIII₁₋ₕMnₕ)F₆ General formula (D):

(hereafter, this tetravalent manganese-activated tetravalent metal fluoride salt phosphor will be referred to as a “second red phosphor”). In general formula (D), Mn is manganese and F is fluorine. In general formula (D), MIII is at least one tetravalent alkaline metal element selected from Ge, Si, Sn, Ti and Zr, like MIII in general formula (C). For the same reasons, MIII is preferably Ti. In general formula (D), MIV is at least one alkaline earth metal element selected from Mg, Ca, Sr, Ba and Zn. From the points of view of the brightness and the stability of the powder characteristics, MIV is preferably Ca.

In general formula (D), the value of “h” representing the composition ratio (concentration) of Mn is 0.001≦h≦0.1, like h in the general formula (C). For the same reasons, the value of “h” is preferably 0.005≦h≦0.5.

Specific example of the second red phosphor include Zn(Ti_{0.98}Mn_{0.02})F₆, Ba(Zr_{0.995}Mn_{0.005}F₆, Ca(Ti_{0.995}Mn_{0.005})F₆, Sr(Zr_{0.98}Mn_{0.02})F₆, and the like. The second red phosphor is not limited to any of these, needless to say.

There is no specific limitation on the mixing ratio of the green phosphor 22 and the red phosphor 23. It is preferable to mix the green phosphor 22 in the range of 5% to 7% by weight with respect to the red phosphor 23. It is more preferable to mix the green phosphor 22 in the range of 15% to 45% by weight with respect to the red phosphor 23.

As the light emitting element 21, a gallium nitride (GaN)-based semiconductor light emitting element that emits blue light having a peak wavelength of 430 nm or longer and 480 nm or shorter (more preferably, 440 nm or longer and 480 nm or shorter) is preferably usable. In the case where a light emitting element that emits light having a peak wavelength shorter than 430 nm is used, the contribution of the blue light component is small and the color rendering property may be undesirably low. In the case where a light emitting element that emits light having a peak wavelength longer than 480 nm is used, the brightness of white may be undesirably decreased.

The sealing agent 24 may be formed of any of epoxy resin, silicone resin, urea resin and the like which are light-transmissive resin materials, but is not limited to being formed of any of these materials. The wavelength conversion portion WC may contain an additive such as SiO₂, TiO₂, ZrO₂, Al₂O₃, Y₂O₃ or the like in addition to the green phosphor 22, the red phosphor 23 and the sealing agent 24 when necessary.

The green phosphor 22 and the red phosphor 23 are not limited to any of the above-described substances. For example, the green phosphor disclosed in Japanese Laid-Open Patent Publication No. 2008-303331 or the red phosphor disclosed in Japanese Laid-Open Patent Publication No. 2010-93132 may be used. The entirety of Japanese Laid-Open Patent Publication No. 2008-303331 and the entirety of Japanese Laid-Open Patent Publication No. 2010-93132 are incorporated herein by reference.

As described above, the present invention is preferably usable in the case where the light source for the backlight unit 20 is a white LED 20a including the light emitting element 21 emitting blue light, the green phosphor 22 and the red phosphor 23. An embodiment of the present invention is not limited to this. The light source for the backlight unit 20 may be any other type of white LED (e.g., bluish yellow-type pseudo white LED), an organic EL element, a cathode ray tube or the like. In such a case also, impulse-type display is provided by use of the optical switch panel 30 to improve the moving image display performance.

### INDUSTRIAL APPLICABILITY

An embodiment of the present invention provides a liquid crystal display device providing high quality moving image display.

### REFERENCE SIGNS LIST

10 Liquid crystal display device
11 Active matrix substrate (TFT substrate)
11a Transparent substrate
12 Color filter substrate (counter substrate)
13 Liquid crystal layer
14 Pixel electrode
15 Thin film transistor (TFT)
16 Scanning line driving circuit (gate driver)
17 Signal line driving circuit (source driver)
18 Color filter layer
18R Red color filter
18G Green color filter
18B Blue color filter
19 Counter electrode
20 Backlight unit
20a White LED
21 Light emitting element
22 Green phosphor
23 Red phosphor
24 Sealing agent
30, 30A Optical switch panel
31 First substrate
31a Transparent substrate
32 Second substrate
32a Transparent substrate
33 Liquid crystal layer
34 First transparent electrode
35 Second transparent electrode
36 Metal line
36D Dummy line
37 Light blocking layer
38 Switching driver
38f Flip-flop
38odd Odd number pixel row switching driver
38even Even number pixel row switching driver
39 Switching voltage selection portion
39a Switching voltage selector
40a First polarizer plate
40b Second polarizer plate
40c Third polarizer plate
100, 200, 300 Liquid crystal display device
GL Scanning line (gate bus line)
SL Signal line (source bus line)
BM Black matrix (light blocking layer)
CP Color display pixel
Px Pixel
R Red pixel
G Green pixel
B Blue pixel
WC Wavelength conversion portion
SR Switching region
CP Connection portion of the metal line and the first transparent electrode
Dodd Odd number pixel row driver
Deven Even number pixel row driver

1. A liquid crystal display device, comprising:
a liquid crystal display panel;
a backlight unit provided on a rear side of the liquid crystal display panel; and
an optical switch panel provided between the liquid crystal display panel and the backlight unit or on an observer side of the liquid crystal display panel, the optical switch panel transmitting and blocking light in a switched manner in one vertical scanning period;
wherein:
the optical switch panel includes a first substrate and a second substrate facing each other and a liquid crystal layer provided between the first substrate and the second substrate;
the first substrate includes a plurality of transparent electrodes formed of a transparent conductive material;
the second substrate includes a second transparent electrode formed of a transparent conductive material, the second transparent electrode facing the plurality of first transparent electrodes; and
the first substrate further includes a plurality of metal lines formed of a metal material, and the plurality of metal lines are each electrically connected with a corresponding first transparent electrode among the plurality of first transparent electrodes.

2. The liquid crystal display device according to claim 1, wherein:
the liquid crystal display panel includes a black matrix; and
a connection portion of each of the plurality of metal lines and each of the plurality of first transparent electrodes, and/or the plurality of metal lines, are located to overlap the black matrix.

3. The liquid crystal display device according to claim 1, wherein:
the optical switch panel includes a plurality of switching regions that are each switchable between a light transmitting state and a light blocking state; and
either one of the plurality of first transparent electrodes is located in each of p y of switching regions.

4. The liquid crystal display device according to claim 3, wherein the plurality of switching regions each correspond to a region, in a display region of the liquid crystal display panel, that is scanned in one horizontal scanning period.

5. The liquid crystal display device according to claim 4, wherein the second substrate includes a light blocking layer provided between two adjacent switching regions among the plurality of switching regions.

6. The liquid crystal display device according to claim 3, wherein the plurality of switching regions each correspond to a region, in a display region of the liquid crystal display panel, that is scanned in two or more horizontal scanning periods.

7. The liquid crystal display device according to claim 6, wherein:
the first substrate includes a plurality of dummy lines not electrically connected with the plurality of first transparent electrodes; and
at least one of the plurality of dummy lines is located between two adjacent metal lines among the plurality of metal lines.

8. The liquid crystal display device according to claim 7, wherein:
the plurality of switching regions each correspond to a region, in a display region of the liquid crystal display panel, that is scanned in M horizontal scanning periods (M is an integer of 2 or greater); and
the plurality of dummy lines are provided in a number that is (M−1) times the number of the plurality of metal lines.

9. A liquid crystal display device, comprising:
a liquid crystal display panel;
a backlight unit provided on a rear side of the liquid crystal display panel; and
an optical switch panel provided between the liquid crystal display panel and the backlight unit or on an observer side of the liquid crystal display panel, the optical switch panel transmitting and blocking light in a switched manner in one vertical scanning period;
wherein:
the optical switch panel includes a plurality of switching regions that are each switchable between a light transmitting state and a light blocking state; and
the plurality of switching regions each correspond to a region, in a display region of the liquid crystal display panel, that is scanned in one horizontal scanning period.

10. The liquid crystal display device according to claim 9, wherein:
the optical switch panel includes a first substrate and a second substrate facing each other and a liquid crystal layer provided between the first substrate and the second substrate;
the first substrate includes a plurality of transparent electrodes formed of a transparent conductive material;
the second substrate includes a second transparent electrode formed of a transparent conductive material, the second transparent electrode facing the plurality of first transparent electrodes; and
either one of the plurality of first transparent electrodes is provided in each of the plurality of switching regions.

11. The liquid crystal display device according to claim 9, wherein:
the optical switch panel includes a plurality of MEMS shutters; and
at least one of the plurality of MEMS shutters is located in each of the plurality of switching regions.

12. The liquid crystal display device according to claim 4, wherein:
the liquid crystal display panel includes a plurality of color display pixels;
the plurality of color display pixels each include N pixels (N is an integer of 3 or greater); and
a region, in the display region of the liquid crystal display panel, that is scanned in one horizontal scanning period is 1 or greater and N or less pixel row(s).

13. The liquid crystal display device according to claim 1, wherein:
the optical switch panel is provided between the liquid crystal display panel and the backlight unit; and
the liquid crystal display device further includes:
a first polarizer plate provided on an observer side of the liquid crystal display panel,
a second polarizer plate provided between the liquid crystal display panel and the optical switch panel, and
a third polarizer plate provided between the optical switch panel and the backlight unit.

14. The liquid crystal display device according to claim 1, wherein:
the optical switch panel is provided on an observer side of the liquid crystal display panel; and
the liquid crystal display device further includes:
a first polarizer plate provided on an observer side of the optical switch panel,
a second polarizer plate provided between the optical switch panel and the liquid crystal display panel, and
a third polarizer plate provided between the liquid crystal display panel and the backlight unit.

15. The liquid crystal display device according to claim 1, wherein the backlight unit includes a light emitting element emitting blue light, a green phosphor absorbing a part of the blue light emitted by the light emitting element and emitting green light, and a red phosphor absorbing a part of the blue light emitted by the light emitting element and emitting red light.
